(19) United States
(12) Patent Application Publication
(10) Pub. No.: US 2024/0306126 A1
(43) Pub. Date: Sep. 12, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/666,840

(22) Filed: May 17, 2024

Related U.S. Application Data
(63) Continuation of application No. PCT/CN2022/133912, filed on Nov. 24, 2022.

(30) Foreign Application Priority Data
Nov. 30, 2021 (CN) 202111439648.5

(51) Int. Cl. H04W 72/04; H04W 72/232; H04W 72/542; H04W 76/19

(52) U.S. Cl. CPC H04W 72/04; H04W 72/232; H04W 72/542; H04W 76/19

(57) ABSTRACT

Present application discloses a method and a device in a communication node for wireless communications. The communication node receives a first signaling which indicates a first RS resource group and a second RS resource group; triggers a first BFR if a first counter reaches a first value; cancels the first BFR with any condition in a first candidate condition set being satisfied; a first condition and a second condition are candidate conditions in the first candidate condition set, the first condition being related to a first random access procedure; whether to initiate the first random access procedure is related to whether the first counter reaches the first value and whether a second counter reaches a second value; the second condition comprises that a first PDCCH is received, the first PDCCH is associated with an identifier of the first node and indicates a first uplink grant for new data transmission.

### CROSS REFERENCE TO RELATED APPLICATIONS

This application is the continuation of the international patent application No. PCT/CN2022/133912, filed on Nov. 24, 2022, and claims the priority benefit of Chinese Patent Application No. 202111439648.5, filed on Nov. 30, 2021, the full disclosure of which is incorporated herein by reference.

### BACKGROUND

### Technical Field

The present application relates to transmission methods and devices in wireless communication systems, and in particular to a method and a device for multi-beam transmission.

### Related Art

The 3rd Generation Partnership Project (3GPP) introduces a mechanism of Beam Failure Recovery (BFR) for the Special Cell (SpCell) in Release 15 (R15), and then a BFR mechanism for Secondary Cell (SCell) is introduced in R16. A Work Item (WI) of “Further enhancements on Multiple Input Multiple Output (MIMO) for NR” has been decided at the 3GPP Radio Access Network (RAN) #80 conference to be conducted for enhancing the Multiple-Transmitter- and Receiver-Point (multi-TRP) BFR mechanism.

### SUMMARY

The 3GPP has now reached a consensus on the need for R17 to support each TRP to perform beam failure detection and recovery procedures independently. For the SpCell scenario, a random access procedure is triggered if both TRPs are detected with beam failure, and the R17-enhanced BFR MAC CE is sent during the random access procedure. How to avoid delayed triggering of the random access procedure, how to avoid resource wastage, how to avoid retransmission, and how to ensure beam failure recovery as soon as possible require enhanced designing.

To address the above problem, the present application provides a solution. For the above problem description, the uu-interface scenario is used as an example; the present application is equally applicable to, for example, the sidelink scenario, to achieve similar technical effects as in the uu-interface scenario. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving a first signaling, the first signaling indicating a first RS (i.e., Reference signal) resource set, the first RS resource set comprising at least a first RS resource group and a second RS resource group, the first RS resource group and the second RS resource group being associated with a first cell, the first RS resource group comprising at least one RS resource, and the second RS resource group comprising at least one RS resource, the first RS resource group and the second RS resource group comprising at least one different RS resource; and incrementing a first counter by 1 whenever a radio link quality evaluated according to the first RS resource group is worse than a first threshold; and incrementing a second counter by 1 whenever a radio link quality evaluated according to the second RS resource group is worse than a second threshold; and
triggering a first BFR as a response to at least the first counter reaching a first value; any condition in a first candidate condition set being satisfied being used to determine cancelling the first BFR;
herein, a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH (i.e., Physical Downlink Control Channel) transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, a problem to be solved in the present application includes: when the first BFR shall be canceled.

In one embodiment, a problem to be solved in the present application includes: how to avoid delayed triggering of a random access procedure.

In one embodiment, characteristics of the above method include: at least the first counter reaching the first value and the second counter reaching a second value being used to determine to initiate the first random access procedure.

In one embodiment, characteristics of the above method include: whether to cancel the first BFR being related to a first random access procedure.

In one embodiment, an advantage of the above method includes: triggering a first random access procedure in a timely manner.

In one embodiment, an advantage of the above method includes: canceling associating the first BFR with the first random access procedure, thus avoiding triggering of BFR too early.

In one embodiment, an advantage of the above method includes: canceling associating the first BFR with the first random access procedure, thus avoiding triggering of BFR too late.

In one embodiment, an advantage of the above method includes: avoid repeated transmission of Medium Access Control (MAC) Control Element (CE).

In one embodiment, an advantage of the above method includes: avoiding resource waste.

According to one aspect of the present application, characterized in that as a response to the first counter reaching the first value, the first random access procedure not being performed is used to determine triggering of the first BFR.

In one embodiment, characteristics of the above method include: whether to trigger the first BFR being related to whether a first random access procedure is being performed.

In one embodiment, characteristics of the above method include: a first BFR being not triggered in a first random access procedure.

In one embodiment, an advantage of the above method includes: avoiding repeated transmissions of MAC CE.

In one embodiment, an advantage of the above method includes: avoiding resource waste.

According to one aspect of the present application, characterized in comprising:

initiating the first random access procedure as a response to at least the first counter reaching the first value and the second counter reaching the second value; the first condition being satisfied as a response to the first random access procedure being initiated; and canceling the first BFR as a response to the first condition being satisfied.

In one embodiment, characteristics of the above method include: canceling the first BFR as a response to the first random access procedure being initiated.

In one embodiment, an advantage of the above method includes: avoiding repeated transmissions of MAC CE.

In one embodiment, an advantage of the above method includes: avoiding resource waste.

According to one aspect of the present application, characterized in comprising:
triggering a first SR (i.e., Scheduling Request) as a response to the action of triggering a first BFR; and, if the first SR is in a pending state, canceling the first SR as a response to the first condition being satisfied.

In one embodiment, characteristics of the above method include: the first random access procedure being used to determine cancelling of a first SR.

In one embodiment, an advantage of the above method includes: avoiding resource waste.

According to one aspect of the present application, characterized in comprising:
triggering a first SR as a response to the action of triggering a first BFR; and initiating a second random access procedure as a response to the action of triggering a first SR; and suspending the second random access procedure as a response to the first condition being satisfied if the second random access procedure is being performed.

In one embodiment, characteristics of the above method include: determining that initiating the first random access procedure is used to determine cancelling of the second random access procedure.

In one embodiment, an advantage of the above method includes: avoiding resource waste.

In one embodiment, an advantage of the above method includes: performing a BFR procedure in a timely manner.

According to one aspect of the present application, characterized in comprising:
determining whether to initiate the first random access procedure according to whether a second random access procedure is being performed, as a response to at least the first counter reaching the first value and the second counter reaching the second value; and not initiating the first random access procedure if the second random access procedure is being performed;
herein, the second random access procedure is triggered by a first SR, the first SR being triggered by the first BFR.

In one embodiment, characteristics of the above method include: a second random access procedure being used for BFR recovery.

In one embodiment, an advantage of the above method includes: accelerating the BFR procedure.

According to one aspect of the present application, characterized in comprising:
determining that the first random access procedure is completed; and the first condition being satisfied as a response to the action of determining that the first random access procedure is completed; and cancelling the first BFR as a response to the first condition being satisfied.

In one embodiment, characteristics of the above method include: the first random access procedure being completed being used to determine cancelling of the first BFR.

In one embodiment, an advantage of the above method includes: increasing the probability of successful completion of the first BFR.

According to one aspect of the present application, characterized in that failure information for the first BFR is indicated in the first random access procedure.

According to one aspect of the present application, characterized in comprising:
transmitting a first BFR MAC CE on a second uplink grant; and determining whether the first condition is satisfied according to whether the second uplink grant is associated with the first random access procedure, as a response to the first BFR MAC CE being transmitted on the second uplink grant; the first condition being satisfied if the second uplink grant is associated with the first random access procedure; and cancelling the first BFR as a response to the first condition being satisfied.

In one embodiment, characteristics of the above method include: whether to cancel the first BFR being related to whether the second uplink grant is received during the first random access procedure.

In one embodiment, characteristics of the above method include: whether to cancel the first BFR being related to whether the second uplink grant is part of resources of the first random access procedure.

In one embodiment, an advantage of the above method includes: ensuring triggering of a first random access procedure in a timely manner.

In one embodiment, an advantage of the above method includes: avoiding resource waste.

According to one aspect of the present application, characterized in comprising:
transmitting a second BFR MAC CE as a response to the action of triggering a first BFR; and
determining whether to monitor a first PDCCH according to whether a first random access procedure is being performed as a response to the action of transmitting a second BFR MAC CE; and not monitoring the first PDCCH if the first random access procedure is being performed.

In one embodiment, an advantage of the above method includes: avoiding triggering of a first BFR in a first random access procedure.

In one embodiment, an advantage of the above method includes: avoiding resource waste.

In one embodiment, an advantage of the above method includes: saving power.

According to one aspect of the present application, characterized in comprising:
transmitting a second BFR MAC CE as a response to the action of triggering a first BFR; and
receiving the first PDCCH transmission; the second condition being satisfied as a response to the first PDCCH transmission being received; and cancelling the first BFR as a response to the second condition being satisfied;
herein, the second BFR MAC CE is used to trigger the first PDCCH transmission.

According to one aspect of the present application, characterized in comprising:
suspending the first random access procedure as a response to the second condition being satisfied.

According to one aspect of the present application, characterized in comprising:
transmitting a third BFR MAC CE on the first uplink grant as a response to the second condition being satisfied.

The present application provides a method in a second node for wireless communications, comprising:
transmitting a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource;
herein, a first counter is incremented by 1 whenever a radio link quality evaluated according to the first RS resource group is worse than a first threshold; and a second counter is incremented by 1 whenever a radio link quality evaluated according to the second RS resource group is worse than a second threshold; and a first BFR is triggered as a response to at least the first counter reaching a first value; any condition in a first candidate condition set being satisfied is used to determine cancelling of the first BFR; a first condition is a candidate condition in the first candidate condition set, the first condition being related to a first random access procedure; whether the first random access procedure is initiated by a receiver of the first signaling is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the receiver of the first signaling, and the first PDCCH transmission indicating a first uplink grant, the first uplink grant being used for new data transmission; the first threshold and the second threshold are configurable; the first value and the second value are configurable, and the first value and the second value are each a positive integer.

According to one aspect of the present application, characterized in that as a response to the first counter reaching the first value, the first random access procedure not being performed is used to determine triggering of the first BFR.

According to one aspect of the present application, characterized in that the first random access procedure is initiated as a response to at least the first counter reaching the first value and the second counter reaching the second value; the first condition is satisfied as a response to the first random access procedure being initiated; and the first BFR is canceled as a response to the first condition being satisfied.

According to one aspect of the present application, characterized in that as a response to the first BFR being triggered, a first SR is triggered; as a response to the first condition being satisfied, if the first SR is in pending state, the first SR is canceled.

According to one aspect of the present application, characterized in that as a response to the first BFR being triggered, a first SR is triggered; as a response to the first SR being triggered, a second random access procedure is initiated by a receiver of the first signaling; as a response to the first condition being satisfied, the second random access procedure is suspended by the receiver of the first signaling if the second random access procedure is being performed.

According to one aspect of the present application, characterized in that as a response to at least the first counter reaching the first value and the second counter reaching the second value, whether a second random access procedure is being performed is used to determine whether the first random access procedure is initiated by a receiver of the first signaling; if the second random access procedure is being performed, the first random access procedure is not initiated by the receiver of the first signaling; herein, the second random access procedure is triggered by a first SR, the first SR being triggered by the first BFR.

According to one aspect of the present application, characterized in that the first random access procedure is determined by a receiver of the first signaling to have been completed; as a response to the first random access procedure being determined by the receiver of the first signaling to have been completed, the first condition is satisfied; as a response to the first condition being satisfied, the first BFR is canceled by the receiver of the first signaling.

According to one aspect of the present application, characterized in that failure information for the first BFR is indicated in the first random access procedure.

According to one aspect of the present application, characterized in comprising:
receiving a first BFR MAC CE on a second uplink grant;
herein, as a response to the first BFR MAC CE being transmitted by a receiver of the first signaling on the second uplink grant, whether the second uplink grant is associated with the first random access procedure is used to determine whether the first condition is satisfied; if the second uplink grant is associated with the first random access procedure, the first condition is satisfied; as a response to the first condition being satisfied, the first BFR is canceled by a receiver of the first signaling.

According to one aspect of the present application, characterized in comprising:
receiving a second BFR MAC CE; and
transmitting a first PDCCH transmission as a response to the action of receiving a second BFR MAC CE;
herein, the first PDCCH is not monitored by a receiver of the first signaling if the first random access procedure is being performed.

According to one aspect of the present application, characterized in comprising:
receiving a second BFR MAC CE; and
transmitting the first PDCCH transmission as a response to the second BFR MAC CE being received;
herein, as a response to the first PDCCH transmission being received by a receiver of the first signaling, the second condition is satisfied; and as a response to the second condition being satisfied, the first BFR is canceled by the receiver of the first signaling.

According to one aspect of the present application, characterized in that as a response to the second condition being satisfied, the first random access procedure is suspended by a receiver of the first signaling.

According to one aspect of the present application, characterized in comprising:
receiving a third BFR MAC CE on the first uplink grant;
herein, the second condition being satisfied is used to trigger the third BFR MAC CE.

According to one aspect of the present application, characterized in comprising:
receiving a second BFR MAC CE; and
determining whether to transmit a first PDCCH transmission according to whether the first random access procedure is being performed as a response to the action of receiving a second BFR MAC CE; and not transmitting the first PDCCH transmission if the first random access procedure is being performed.

The present application provides a first node for wireless communications, comprising:
a first receiver, receiving a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource; and incrementing a first counter by 1 whenever a radio link quality evaluated according to the first RS resource group is worse than a first threshold; and incrementing a second counter by 1 whenever a radio link quality evaluated according to the second RS resource group is worse than a second threshold; and
a first transceiver, triggering a first BFR as a response to at least the first counter reaching a first value; any condition in a first candidate condition set being satisfied being used to determine cancelling the first BFR;
herein, a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

The present application provides a second node for wireless communications, comprising:
a second transmitter, transmitting a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource;
herein, a first counter is incremented by 1 whenever a radio link quality evaluated according to the first RS resource group is worse than a first threshold; and a second counter is incremented by 1 whenever a radio link quality evaluated according to the second RS resource group is worse than a second threshold; and a first BFR is triggered as a response to at least the first counter reaching a first value; any condition in a first candidate condition set being satisfied is used to determine cancelling of the first BFR; a first condition is a candidate condition in the first candidate condition set, the first condition being related to a first random access procedure; whether the first random access procedure is initiated by a receiver of the first signaling is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the receiver of the first signaling, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, compared with the prior art, the present application is advantageous in the following aspects:
triggering the first random access procedure in a timely manner;
avoiding triggering of the BFR too early;
avoiding triggering of the BFR too late;
avoiding repeated transmissions of MAC CE;
avoiding waste of resources;
performing the BFR recovery procedure in a timely manner;
speeding up the BFR recovery procedure;
increasing the probability of successful completion of the first BFR;
ensuring timely triggering of the first random access procedure;
saving power.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a flowchart of radio signal transmission according to a third embodiment of the present application.

FIG. 8 illustrates a schematic diagram of a first random access procedure not being performed being used to determine triggering of a first BFR according to one embodiment of the present application.

FIG. 9 illustrates a schematic diagram of determining whether to monitor a first PDCCH according to whether a first random access procedure is being performed according to one embodiment of the present application.

FIG. 10 illustrates a schematic diagram of a first random access procedure being initiated being used to determine that a first condition is satisfied according to one embodiment of the present application.

FIG. 11 illustrates a schematic diagram of a first random access procedure being completed being used to determine that a first condition is satisfied according to one embodiment of the present application.

FIG. 12 illustrates a schematic diagram of determining whether to initiate a first random access procedure according to whether a second random access procedure is being performed according to one embodiment of the present application.

FIG. 13 illustrates a structure block diagram of a processing device used in a first node according to one embodiment of the present application.

FIG. 14 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

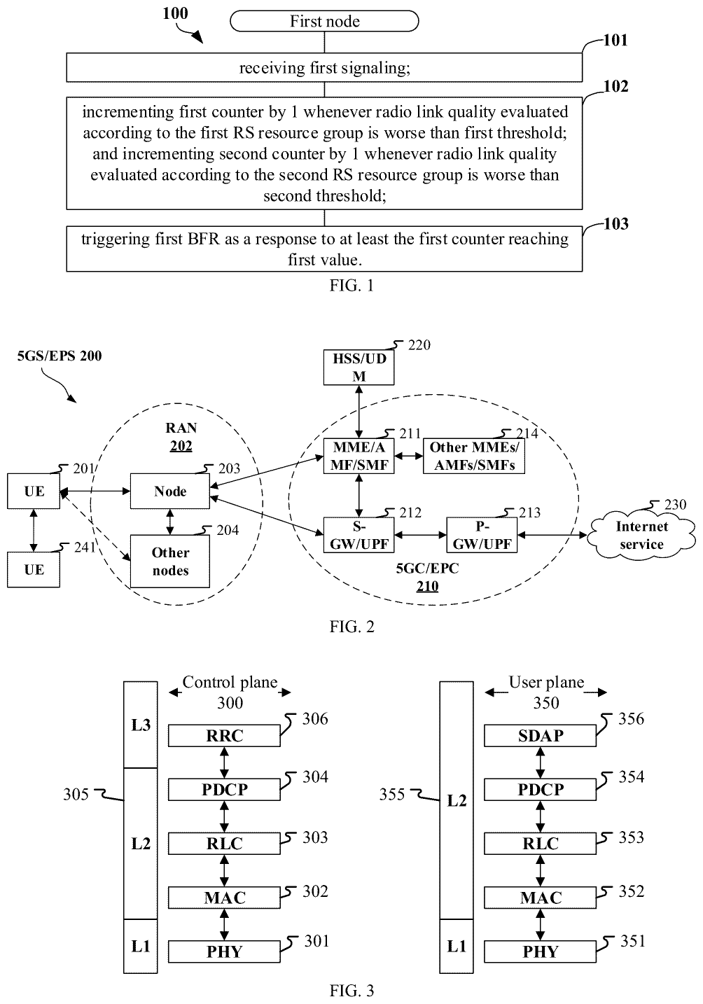

Embodiment 1 illustrates a flowchart of transmission of a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in this application receives a first signaling in step 101, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource; and in step 102, increments a first counter by 1 whenever a radio link quality evaluated according to the first RS resource group is worse than a first threshold; and increments a second counter by 1 whenever a radio link quality evaluated according to the second RS resource group is worse than a second threshold; and in step 103, triggers a first BFR as a response to at least the first counter reaching a first value; herein, any condition in a first candidate condition set being satisfied is used to determine cancelling of the first BFR; a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, at least a former of the first RS resource group and the second RS resource group belongs to a first cell.

In one embodiment, both the first RS resource group and the second RS resource group belong to the first cell.

In one embodiment, the first RS resource group belongs to the first cell, while the second RS resource group belongs to the second cell.

In one embodiment, the first cell is a Special Cell (SpCell) of the first node.

In one subembodiment, the SpCell is a Primary Cell (PCell).

In one subembodiment, the SpCell is a Primary SCG Cell (PSCell).

In one subembodiment, if the first cell is a PCell, a cell group to which the first cell belongs is a Master Cell Group (MCG).

In one subembodiment, if the first cell is a PSCell, a cell group to which the first cell belongs is a Secondary Cell Group (SCG).

In one embodiment, a second cell is a candidate cell for L1/L2 mobility configured for the first cell.

In one subembodiment, the second cell provides additional physical resources on top of the second cell.

In one subembodiment, the first cell and the second cell are intra-frequency cells.

In one subembodiment, the first cell and the second cell are inter-frequency cells.

In one subembodiment, a Physical Cell Identifier (PCI) of the first cell is different from a PCI of the second cell.

In one subembodiment, the first cell is configured with a ServCellIndex, while the second cell is not configured with a ServCellIndex.

In one subembodiment, the first cell is associated with one TRP and the second cell is associated with another TRP, the one TRP and the other TRP belonging to a same Distributed Unit (DU).

In one subembodiment, the first cell is associated with one TRP and the second cell is associated with another TRP, the one TRP and the other TRP belonging to two different DUs, respectively.

In one embodiment, the second cell is configured.

In one subembodiment, the first cell is a PCell, the second cell is not an SCell in an MCG, and, the second cell is not any cell in an SCG.

In one subembodiment, the first cell is a PSCell, the second cell is not an SCell in an SCG, and, the second cell is not any cell in an MCG.

In one embodiment, the second cell is not configured.

In one embodiment, which RS resources are included in the first RS resource group is configured by the second node.

In one embodiment, which RS resources are included in the first RS resource group is determined by the first node.

In one embodiment, which RS resources are included in the second RS resource group is configured by the second node.

In one embodiment, which RS resources are included in the second RS resource group is determined by the first node.

In one embodiment, each RS resource in each RS resource subgroup of each RS resource group in the first RS resource set is determined according to the first signaling.

In one embodiment, an index of each RS resource in each RS resource subgroup of each RS resource group in the first RS resource set is determined according to the first signaling.

In one embodiment, the first signaling is used to configure RS resources in each RS resource subgroup of each RS resource group in the first RS resource set.

In one embodiment, a transmitter of the first signaling is a maintenance base station for a first cell.

In one embodiment, a transmitter of the first signaling is a maintenance base station for a second cell.

In one embodiment, a transmitter of the first signaling is a maintenance base station for one of serving cells of the first node other than the first cell.

In one subembodiment, the first cell is a PCell of the first node, and the one serving cell is at least one of a SCell in an MCG, or a PSCell or a SCell in an SCG.

In one subembodiment, the first cell is a PSCell of the first node, and the one serving cell is at least one of a SCell in an SCG, or a PCell or a SCell in an MCG.

In one embodiment, the first signaling is used to configure the first RS resource set.

In one embodiment, the first signaling is used to determine the first RS resource set.

In one embodiment, the first signaling implicitly indicates the first RS resource set.

In one embodiment, the first signaling explicitly indicates the first RS resource set.

In one embodiment, the first signaling is used to determine an index of each RS resource in the first RS resource set.

In one embodiment, the first signaling indicates an index of each RS resource in the first RS resource set.

In one embodiment, the first signaling comprises a Downlink (DL) signaling.

In one embodiment, the first signaling comprises a Sidelink (SL) signaling.

In one embodiment, the first signaling is a Radio Resource Control (RRC) message.

In one embodiment, the first signaling comprises at least one RRC message.

In one embodiment, the first signaling comprises at least one Information Element (IE) in an RRC message.

In one embodiment, the first signaling comprises at least one Field in an RRC message.

In one embodiment, the first signaling comprises a RRCReconfiguration message.

In one embodiment, the first signaling comprises a System Information Block 1 (SIB1) message.

In one embodiment, the first signaling comprises a SystemInformation message.

In one embodiment, the first signaling is a field or an IE other than an IE RadioLinkMonitoringConfig.

In one embodiment, the first signaling comprises at least one IE other than an IE RadioLinkMonitoringConfig.

In one embodiment, the first signaling comprises M sub-signalings, of which each sub-signaling comprises an IE RadioLinkMonitoringConfig, M being a number of Bandwidth Parts (BWPs).

In one embodiment, the first signaling comprises at least an IE RadioLinkMonitoringConfig.

In one embodiment, the first signaling comprises at least a failureDetectionResourcesToAddModList field.

In one embodiment, the first signaling is a failureDetectionResourcesToAddModList field.

In one embodiment, at least one IE or at least one field in the first signaling other than an IE RadioLinkMonitoringConfig indicates the first RS resource set.

In one embodiment, the first RS resource set includes at least two RS resource groups.

In one embodiment, the first RS resource set includes two RS resource groups.

In one embodiment, the first RS resource set includes more than two RS resource groups.

In one embodiment, all of RS resource groups in the first RS resource set belong to the first cell.

In one embodiment, all of RS resource groups in the first RS resource set include at least one RS resource group belonging to the first cell and at least one RS resource group belonging to the second cell; where the second cell is configured.

In one embodiment, the at least one RS resource in the first RS resource group is used for a BFR procedure.

In one embodiment, the at least one RS resource in the first RS resource group is used for a Beam Failure Detection procedure.

In one embodiment, the at least one RS resource in the first RS resource group is used for Link recovery procedures.

In one embodiment, one RS resource in the first RS resource group is a Dedicated demodulation reference signal (DMRS) resource.

In one embodiment, one RS resource in the first RS resource group is a Dedicated demodulation reference signal (DMRS) resource.

In one embodiment, one RS resource in the first RS resource group is a Phase-tracking reference signal (PTRS).

In one embodiment, one RS resource in the first RS resource group is a Channel state information Reference Signal (CSI-RS) resource.

In one embodiment, one RS resource in the first RS resource group is a Synchronization Signal Block (SSB).

In one embodiment, one RS resource in the first RS resource group is a Synchronization Signal (SS)/Physical Broadcast Channel (PBCH) block.

In one embodiment, one RS resource in the first RS resource group is a CSI-RS resource identified by csi-RS-Index, or the RS resource is an SSB resource identified by ssb-Index.

In one embodiment, one RS resource in the first RS resource group is a CSI-RS resource identified by csi-rs, or the RS resource is an SSB resource identified by ssb.

In one embodiment, one RS resource in the first RS resource group is a CSI-RS resource identified by NZP-CSI-RS-ResourceId, or the RS resource is an SSB resource identified by SSB-Index.

In one embodiment, any RS resource in the first RS resource group is periodic.

In one embodiment, any RS resource in the first RS resource group is aperiodic.

In one embodiment, any RS resource in the first RS resource group is quasi-colocation(QCL)-Type D.

In one embodiment, each RS resource in the first RS resource group is explicitly indicated by the first signaling.

In one embodiment, each RS resource in the first RS resource group is implicitly indicated by the first signaling.

In one embodiment, the at least one RS resource in the second RS resource group is used for a BFR procedure.

In one embodiment, the at least one RS resource in the second RS resource group is used for beam failure detection.

In one embodiment, the at least one RS resource in the second RS resource group is used for a link recovery procedure.

In one embodiment, one RS resource in the second RS resource group is a CSI-RS resource.

In one embodiment, one RS resource in the second RS resource group is an SSB resource.

In one embodiment, one RS resource in the second RS resource group is an SS/PBCH.

In one embodiment, one RS resource in the second RS resource group is a CSI-RS resource identified by csi-RS-Index, or is an SSB resource identified by ssb-Index.

In one embodiment, one RS resource in the second RS resource group is a CSI-RS resource identified by csi-rs, or is an SSB resource identified by ssb.

In one embodiment, one RS resource in the second RS resource group is a CSI-RS resource identified by NZP-CSI-RS-ResourceId, or is an SSB resource identified by SSB-Index.

In one embodiment, any RS resource in the second RS resource group is periodic.

In one embodiment, any RS resource in the second RS resource group is aperiodic.

In one embodiment, any RS resource in the second RS resource group is QCL-Type D.

In one embodiment, each RS resource in the second RS resource group is explicitly indicated by the first signaling.

In one embodiment, each RS resource in the second RS resource group is implicitly indicated by the first signaling.

In one embodiment, the at least one RS resource in the first RS resource group belongs to a same BWP as the at least one RS resource in the second RS resource group.

In one embodiment, the at least one RS resource in the first RS resource group and the at least one RS resource in the second RS resource group belong to two different BWPs.

In one embodiment, the at least one RS resource in the first RS resource group belongs to one TRP and the at least one RS resource in the second RS resource group belongs to another TRP.

In one embodiment, the at least one RS resource in the first RS resource group is used for a link recovery procedure for one TRP and the at least one RS resource in the second RS resource group is used for a link recovery procedure for another TRP.

In one embodiment, the at least one RS resource in the first RS resource group is used to determine whether a beam failure has occurred in one TRP and the at least one RS resource in the second RS resource group is used to determine whether a beam failure has occurred in another TRP.

In one embodiment, both the one TRP and the other TRP belong to the first cell.

In one embodiment, the first RS resource group corresponds to one q̅₀ and the second RS resource group corresponds to another q̅₀.

In one embodiment, the first RS resource group is a q̅₀ and the second RS resource group is another q̅₀.

In one embodiment, the first RS resource group includes q̅₀ in its name and the second RS resource group includes q̅₀ in its name.

In one embodiment, both the first RS resource group and the second RS resource group belong to the first cell.

In one embodiment, the first RS resource group and the second RS resource group are associated with the first cell.

In one embodiment, the at least one RS resource in the first RS resource group and the at least one RS resource in the second RS resource group both belong to the first cell.

In one embodiment, the at least one RS resource in the first RS resource group and the at least one RS resource in the second RS resource group are both transmitted on the first cell.

In one embodiment, the at least one RS resource in the first RS resource group and the at least one RS resource in the second RS resource group are both transmitted on the first cell.

In one embodiment, the at least one RS resource in the first RS resource group and the at least one RS resource in the second RS resource group are configured for the first cell.

In one embodiment, the one TRP belongs to the first cell and the other TRP belongs to the second cell; where the second cell is configured.

In one embodiment, the first RS resource group belongs to the first cell while the second RS resource group belongs to the second cell; where the second cell is configured.

In one embodiment, the first RS resource group is associated with the first cell while the second RS resource group is associated with the second cell; where the second cell is configured.

In one embodiment, the at least one RS resource in the first RS resource group is transmitted on the first cell, and the at least one RS resource in the second RS resource group is transmitted on the second cell; where the second cell is configured.

In one embodiment, the phrase that a radio link quality evaluated according to the first RS resource group is worse than a first threshold comprises that the radio link quality evaluated according to the first RS resource group is greater than the first threshold; the first threshold including a Block Error Ratio (BLER) threshold.

In one embodiment, the phrase that a radio link quality evaluated according to the first RS resource group is worse than a first threshold comprises that the radio link quality evaluated according to the first RS resource group is no less than the first threshold; the first threshold including a BLER threshold.

In one embodiment, the phrase that a radio link quality evaluated according to the first RS resource group is worse than a first threshold comprises that the radio link quality evaluated according to the first RS resource group is less than the first threshold; the first threshold including at least one of a Reference Signal Received Power (RSRP) threshold, or a Reference Signal Received Quality (RSRQ) threshold, or a Signal to Interference plus Noise Ratio (SINR) threshold.

In one embodiment, the phrase that a radio link quality evaluated according to the first RS resource group is worse than a first threshold comprises that the radio link quality evaluated according to the first RS resource group is no greater than the first threshold.

In one embodiment, the sentence “increments a first counter by 1 whenever a radio link quality evaluated according to the first RS resource group is worse than a first threshold” includes that: whenever the radio link quality evaluated according to the first RS resource group is worse than a first threshold, the physical layer of the first node transmits a first indication to a higher layer of the first node, and the higher layer of the first node, upon receiving the first indication, increments the first counter by 1.

In one embodiment, whenever a radio link quality evaluated according to the first RS resource group is worse than a first threshold, at a reporting period corresponding to the first evaluation period, the physical layer of the first node transmits a first indication to a higher layer of the first node, and the higher layer of the first node increments a first counter by 1 upon reception of the first indication.

In one embodiment, the first indication is a beam failure instance indication.

In one embodiment, the first indication is used to indicate that a beam failure instance with respect to the first RS resource group is detected.

In one embodiment, the sentence “increments a first counter by 1 whenever a radio link quality evaluated according to the first RS resource group is worse than a first threshold” includes: evaluating a radio link quality according to the first RS resource group at each first evaluation period, and incrementing the first counter by 1 if the radio link quality evaluated according to the first RS resource group is worse than a first threshold.

In one embodiment, the phrase a radio link quality evaluated according to the first RS resource group comprises: a radio link quality obtained by performing a measurement for at least one RS resource in the first RS resource group.

In one embodiment, the phrase a radio link quality evaluated according to the first RS resource group comprises: a radio link quality obtained by performing a measurement for each RS resource in the first RS resource group.

In one embodiment, the phrase a radio link quality evaluated according to the first RS resource group comprises: a radio link quality obtained by performing a measurement for at least one RS resource in one subset of the first RS resource group.

In one embodiment, the phrase a radio link quality evaluated according to the first RS resource group comprises: a radio link quality obtained by performing a measurement for each RS resource in one subset of the first RS resource group.

In one embodiment, the one subset of the first RS resource group comprises at least one RS resource.

In one embodiment, the number of RS resources in the one subset of the first RS resource group is not greater than the number of RS resources in the first RS resource group.

In one embodiment, the phrase that a radio link quality evaluated according to the second RS resource group is worse than a second threshold comprises that the radio link quality evaluated according to the second RS resource group is greater than the second threshold; the second threshold including a Block Error Ratio (BLER) threshold.

In one embodiment, the phrase that a radio link quality evaluated according to the second RS resource group is worse than a second threshold comprises that the radio link quality evaluated according to the second RS resource group is no less than the second threshold; the second threshold including a BLER threshold.

In one embodiment, the phrase that a radio link quality evaluated according to the second RS resource group is worse than a second threshold comprises that the radio link quality evaluated according to the second RS resource group is less than the second threshold; the second threshold including at least one of an RSRP threshold, or an RSRQ threshold, or a SINR threshold.

In one embodiment, the phrase that a radio link quality evaluated according to the second RS resource group is worse than a second threshold comprises that the radio link quality evaluated according to the second RS resource group is no greater than the second threshold.

In one embodiment, the sentence “increments a second counter by 1 whenever a radio link quality evaluated according to the second RS resource group is worse than a second threshold” includes that: whenever the radio link quality evaluated according to the second RS resource group is worse than a second threshold, the physical layer of the first node transmits a second indication to a higher layer of the first node, and the higher layer of the first node, upon receiving the second indication, increments the second counter by 1.

In one embodiment, whenever a radio link quality evaluated according to the second RS resource group is worse than a second threshold, at a reporting period corresponding to the second evaluation period, the physical layer of the first node transmits a second indication to a higher layer of the first node, and the higher layer of the first node increments a second counter by 1 upon reception of the second indication.

In one embodiment, the second indication is a beam failure instance indication.

In one embodiment, the second indication is used to indicate that a beam failure instance with respect to the second RS resource group is detected.

In one embodiment, the sentence “increments a second counter by 1 whenever a radio link quality evaluated according to the second RS resource group is worse than a second threshold” includes: evaluating a radio link quality according to the second RS resource group at each second evaluation period, and incrementing the second counter by 1 if the radio link quality evaluated according to the second RS resource group is worse than a second threshold.

In one embodiment, the phrase a radio link quality evaluated according to the second RS resource group comprises: a radio link quality obtained by performing a measurement for at least one RS resource in the second RS resource group.

In one embodiment, the phrase a radio link quality evaluated according to the second RS resource group comprises: a radio link quality obtained by performing a measurement for each RS resource in the second RS resource group.

In one embodiment, the phrase a radio link quality evaluated according to the second RS resource group comprises: a radio link quality obtained by performing a measurement for at least one RS resource in one subset of the second RS resource group.

In one embodiment, the phrase a radio link quality evaluated according to the second RS resource group comprises: a radio link quality obtained by performing a measurement for each RS resource in one subset of the second RS resource group.

In one embodiment, the one subset of the second RS resource group comprises at least one RS resource.

In one embodiment, the number of RS resources in the one subset of the second RS resource group is not greater than the number of RS resources in the second RS resource group.

In one embodiment, the meaning of whenever includes: once, or, as long as, or, if.

In one embodiment, the meaning of being evaluated includes measuring.

In one embodiment, the meaning of being evaluated includes filtering based on measurement results.

In one embodiment, the meaning of being evaluated includes processing measurement results.

In one embodiment, the meaning of being evaluated includes processing measurement results and comparing them with at least one pre-defined threshold.

In one embodiment, the meaning of being evaluated includes analyzing.

In one embodiment, the meaning of being evaluated includes calculating.

In one embodiment, the meaning of being evaluated includes counting up.

In one embodiment, the radio link quality includes an RSRP measurement result.

In one embodiment, the radio link quality includes an RSRQ measurement result.

In one embodiment, the radio link quality includes a SINR measurement result.

In one embodiment, the radio link quality includes a BLER measurement result.

In one embodiment, the higher layer is a MAC layer.

In one embodiment, the higher layer is an RRC layer.

In one embodiment, the reporting period comprises at least 1 slot.

In one embodiment, the reporting period is 2 ms.

In one embodiment, the reporting period is 10 ms.

In one embodiment, the reporting period is a shortest period for all RS resources in the RS resource subgroup.

In one embodiment, an evaluation period comprises a time interval of at least 1 millisecond (ms).

In one embodiment, an evaluation period is 1 Frame.

In one embodiment, an evaluation period is 1 Radio Frame.

In one embodiment, the above evaluation period comprises the first evaluation period.

In one embodiment, the above evaluation period comprises the second evaluation period.

In one embodiment, the first evaluation period and the second evaluation period are the same.

In one embodiment, the first evaluation period and the second evaluation period are different.

In one embodiment, the first evaluation period and the second evaluation period are temporally aligned.

In one embodiment, a start of the first evaluation period is the same as a start of the second evaluation period, and an end of the first evaluation period is the same as an end of the second evaluation period.

In one embodiment, the first evaluation period and the second evaluation period are not temporally aligned.

In one embodiment, a reporting period corresponding to the first evaluation period is the same as a reporting period corresponding to the second evaluation period.

In one embodiment, a reporting period corresponding to the first evaluation period is different from a reporting period corresponding to the second evaluation period.

In one embodiment, an evaluation period comprises at least 1 slot, the slot(s) comprising at least one of slot(s), or subframe(s), or Radio Frame(s), or frame(s), or multiple Orthogonal Frequency Division Multiplexing (OFDM) symbols, or multiple Single Carrier Frequency Division Multiple Access (SC-FDMA) symbols.

In one embodiment, the action “triggering a first BFR as a response to at least the first counter reaching a first value” includes: as a response to the action of incrementing the first counter by 1, if the first counter reaches the first value, triggering the first BFR.

In one embodiment, the action “triggering a first BFR as a response to at least the first counter reaching a first value” includes: as a response to the action of incrementing the first counter by 1, if the first counter reaches the first value, and, the second BFR is not triggered or the second BFR is not in a pending state, triggering the first BFR.

In one embodiment, the action “triggering a first BFR as a response to at least the first counter reaching a first value” includes: at least the first counter reaching the first value being used to determine triggering of the first BFR.

In one embodiment, the action “triggering a first BFR as a response to at least the first counter reaching a first value” includes: the first counter reaching the first value when the first BFR is triggered.

In one embodiment, the phrase reaching refers to: not less than.

In one embodiment, the phrase reaching refers to: greater than.

In one embodiment, the phrase reaching refers to: equal to.

In one embodiment, the phrase reaching refers to: equal to or greater than.

In one embodiment, the action of triggering a first BFR includes: triggering a BFR for the first RS resource group.

In one embodiment, the action of triggering a first BFR includes: triggering an enhanced BFR for the first RS resource group.

In one embodiment, the first BFR is associated with the first RS resource group.

In one embodiment, as a response to the first counter reaching a first value, triggering a first BFR.

In one embodiment, as a response to the first counter reaching a first value, whether the first BFR is triggered is related to whether the first random access procedure is being performed.

In one embodiment, as a response to the first counter reaching a first value, whether the first BFR is triggered is unrelated to whether the first random access procedure is being performed.

In one embodiment, as a response to the first counter reaching a first value, whether the first BFR is triggered is related to whether the second BFR is triggered.

In one embodiment, as a response to the first counter reaching a first value, whether the first BFR is triggered is unrelated to whether the second BFR is triggered.

In one embodiment, as a response to the first counter reaching a first value, the first BFR is triggered if the first random access procedure is not being performed.

In one embodiment, as a response to the first counter reaching a first value, the first BFR is triggered if the second BFR is not triggered.

In one embodiment, whenever the first counter is incremented by 1, the first BFR is triggered if the first counter reaches the first value.

In one embodiment, whenever the second counter is incremented by 1, the second BFR is triggered if the second counter reaches the second value.

In one embodiment, the first value is equal to beamFailureInstanceMaxCount.

In one embodiment, the first value is configured by beamFailureInstanceMaxCount.

In one embodiment, the first value is equal to a value of a parameter that includes beamFailureInstanceMaxCount in its name.

In one embodiment, the first value is configured by a parameter that includes beamFailureInstanceMaxCount in its name.

In one embodiment, the first value is equal to the value of a parameter, the parameter including at least one of beam or Failure or Instance or Max or Count or TRP or RS or Set or per in its name.

In one embodiment, the first value is no greater than 512.

In one embodiment, the first value is no greater than 10.

In one embodiment, the first condition set comprises only the first condition and the second condition.

In one embodiment, the first condition set comprises at least the first condition and the second condition.

In one embodiment, the first condition set comprises at least one condition other than the first condition and the second condition.

In one embodiment, the first condition being satisfied is used to determine cancelling of the first BFR.

In one embodiment, the second condition being satisfied is used to determine cancelling of the first BFR.

In one embodiment, as a response to the first condition being satisfied, the first BFR is canceled.

In one embodiment, as a response to the first condition being satisfied, the first BFR is canceled.

In one embodiment, the meaning of canceling includes to cancel.

In one embodiment, the action that the first BFR is canceled comprises: canceling all BFRs triggered for the first RS resource group.

In one embodiment, the action that the first BFR is canceled is used to determine not to trigger the generation of a MAC CE for the first RS resource group.

In one embodiment, the action that the first BFR is canceled is used to determine not to trigger the evaluation of candidate beams for the first RS resource group.

In one embodiment, the action that the first BFR is canceled is used to determine not to trigger an SR for the first BFR.

In one embodiment, the action that the first BFR is canceled is used to determine that the first BFR is not in a pending state.

In one embodiment, the phrase the first condition being related to a first random access procedure comprises that at least the first random access procedure is being performed when the first condition is satisfied.

In one embodiment, the phrase the first condition being related to a first random access procedure comprises that the first condition is related to the first random access being triggered.

In one embodiment, the phrase the first condition being related to a first random access procedure comprises that the first condition is related to the first random access procedure being initiated.

In one embodiment, the phrase the first condition being related to a first random access procedure comprises that the first condition is related to a type of the first random access procedure.

In one subembodiment, the type of the first random access procedure includes Contention Free Random Access (CFRA) and Contention based Random Access (CBRA).

In one subembodiment, the type of the first random access procedure includes 4-stepRA and 2-stepRA.

In one embodiment, the phrase the first condition being related to a first random access procedure comprises that the first condition is related to the first random access procedure being completed.

In one embodiment, the phrase the first condition being related to a first random access procedure comprises that: the first condition is related to whether failure information for the first BFR is transmitted in the first random access procedure.

In one embodiment, the phrase the first condition being related to a first random access procedure comprises that: the first condition is related to whether a random access preamble for the first random access procedure is associated with the first RS resource group.

In one embodiment, the second value is equal to beamFailureInstanceMaxCount.

In one embodiment, the second value is configured by beamFailureInstanceMaxCount.

In one embodiment, the second value is equal to a value of a parameter that includes beamFailureInstanceMaxCount in its name.

In one embodiment, the second value is configured by a parameter that includes beamFailureInstanceMaxCount in its name.

In one embodiment, the second value is equal to the value of a parameter, the parameter including at least one of beam or Failure or Instance or Max or Count or TRP or RS or Set or per in its name.

In one embodiment, the second value is no greater than 512.

In one embodiment, the second value is no greater than 10.

In one embodiment, the first random access procedure is initiated.

In one embodiment, the first random access procedure is not transmitted.

In one embodiment, the phrase whether to initiate the first random access procedure is related to at least whether the first counter reaches the first value and whether the second counter reaches a second value comprises: at least the first counter reaching the first value and the second counter reaching the second value being used to determine initiation of the first random access procedure.

In one embodiment, the phrase whether to initiate the first random access procedure is related to at least whether the first counter reaches the first value and whether the second counter reaches a second value comprises: the first counter reaching the first value and the second counter reaching the second value being one condition for the initiation of the first random access procedure.

In one embodiment, the phrase whether to initiate the first random access procedure is related to at least whether the first counter reaches the first value and whether the second counter reaches a second value comprises: when the first random access procedure is initiated, the first counter reaches the first value and the second counter reaches the second value.

In one embodiment, the first BFR being in a pending state comprises that the first BFR is triggered and BFR information for the first RS resource group is not transmitted in any MAC CE.

In one embodiment, the first BFR being in a pending state comprises that the first BFR is triggered and any MAC CE indicating that a beam failure against the first RS resource group is detected is not transmitted.

In one embodiment, the first BFR being in a pending state comprises that the first BFR is triggered and any MAC CE indicating that a beam failure against the first RS resource group is detected is not transmitted.

In one embodiment, the first BFR being in a pending state comprises that the first BFR is triggered and any MAC CE indicating that a beam failure against the first RS resource group is detected is not transmitted.

In one embodiment, the first BFR being in a pending state comprises waiting for a MAC CE to be generated.

In one embodiment, the pending state means Pending.

In one embodiment, the pending state means waiting to be triggered.

In one embodiment, after the first counter reaches the first value, the second counter reaches the second value.

In one embodiment, after the first counter equals the first value, the second counter equals the second value.

In one embodiment, during at least a time interval between a time when the first counter is equal to the first value and a time when the second counter is equal to the second value, a beam failure recovery for the first RS resource group has not been successfully completed.

In one embodiment, during at least a time interval between a time when the first counter is equal to the first value and a time when the second counter is equal to the second value, the first BFR is in a pending state.

In one embodiment, during at least a time interval between a time when the first counter is equal to the first value and a time when the second counter is equal to the second value, the second BFR MAC CE is transmitted and the first PDCCH is not received.

In one embodiment, during at least a time interval between a time when the first counter is equal to the first value and a time when the second counter is equal to the second value, the second BFR MAC CE is not transmitted.

In one embodiment, during at least a time interval between a time when the first BFR is triggered and a time when the first random access procedure is initiated, the second BFR is triggered.

In one subembodiment, at least the second counter reaching the second value is used to determine the triggering of the second BFR.

In one embodiment, during at least a time interval between a time when the first BFR is triggered and a time when the first random access procedure is initiated, the second BFR is not triggered.

In one subembodiment, the second counter not reaching the second value is used to determine that the second BFR is not triggered.

In one subembodiment, the first BFR and the second BFR not being able to be triggered at the same time is used to determine that the second BFR is not triggered.

In one subembodiment, the first random access procedure being triggered is used to determine that the second BFR is not triggered.

In one embodiment, as a response to at least the second counter reaching a second value, the second BFR is triggered.

In one embodiment, as a response to at least the second counter reaching a second value, the second BFR is triggered if the first BFR is in a pending state.

In one embodiment, as a response to at least the second counter reaching a second value, the second BFR is triggered if the first BFR is in a pending state, and as a response to both the first BFR and the second BFR being in a pending state, the first random access procedure is triggered.

In one embodiment, a first BFR is triggered as a response to at least the first counter reaching a first value, and a second BFR is triggered as a response to at least the second counter reaching a second value.

In one embodiment, as a response to both the first BFR and the second BFR being triggered, initiating the first random access procedure.

In one embodiment, as a response to both the first BFR and the second BFR being in a pending state, initiating the first random access procedure.

In one embodiment, as a response to both the first BFR and the second BFR being not successfully completed, initiating the first random access procedure.

In one embodiment, as a response to the first BFR being in a pending state and the second BFR being in a pending state, initiating the first random access procedure.

In one embodiment, as a response to the first BFR not being successfully completed and the second BFR not being successfully completed, initiating the first random access procedure.

In one embodiment, the action of triggering a second BFR includes: triggering a BFR for the second RS resource group.

In one embodiment, the action of triggering a second BFR includes: triggering an enhanced BFR for the second RS resource group.

In one embodiment, the second BFR is associated with the second RS resource group.

In one embodiment, the first BFR and the second BFR cannot be triggered at the same time.

In one embodiment, the first BFR and the second BFR can be triggered at the same time.

In one embodiment, as a response to at least the second counter reaching a second value, triggering the first random access procedure if the first BFR is in a pending state; where as a response to at least the second counter reaching a second value, the second BFR is not triggered.

In one embodiment, as a response to at least the first counter reaching the first value and the second counter reaching the second value, initiating the first random access procedure.

In one embodiment, as a response to a beam failure with respect to the second RS resource group being detected, when an evaluation of candidate beams for the second RS resource group has been successfully completed, if the first BFR is in a pending state, initiating the first random access procedure.

In one embodiment, as a response to a beam failure with respect to the first RS resource group being detected and an evaluation of candidate beams for the first RS resource group having been successfully completed, and, as a response to a beam failure with respect to the second RS resource group being detected and an evaluation of candidate beams for the second RS resource group having been successfully completed, initiating the first random access procedure.

In one embodiment, the first counter reaching the first value is used to determine the triggering of the first BFR, while the second counter reaching the second value is used to determine the triggering of the second BFR, if the first BFR is in a pending state and the second BFR is in a pending state, the first random access procedure is initiated.

In one embodiment, the first BFR not being successfully completed comprises: the first PDCCH not being received.

In one embodiment, the first BFR not being successfully completed comprises: the first BFR not being canceled.

In one embodiment, the first BFR not being successfully completed comprises: indicating that a MAC CE in which a beam failure is detected against the first RS resource group is not transmitted.

In one embodiment, the first BFR not being successfully completed comprises: a MAC CE in which a beam failure is detected against the first RS resource group being transmitted, and a response for the MAC CE being not received.

In one embodiment, the second condition comprises that the first PDCCH transmission is received and that the first PDCCH transmission indicates the first uplink grant, the first uplink grant being used for a new data transmission, that the first PDCCH transmission is a PDCCH transmission received with respect to a Hybrid Automatic Repeat-Request (HARQ) process used for transmitting a BFR MAC CE, and that the BFR MAC CE comprises one piece of BFR information, the BFR information being associated with the first BFR.

In one embodiment, the second condition comprises that the first PDCCH transmission is received and that a process used to receive the first PDCCH transmission is a HARQ process used to transmit a second BFR MAC CE, that the second BFR MAC CE indicates that at least a beam failure against the first RS resource group is detected, and that the first PDCCH transmission is associated with the first identifier of the first node, the first PDCCH transmission indicating a first uplink grant, the first uplink grant being used for a new data transmission.

In one embodiment, the first PDCCH transmission being received is used to determine that the second condition is satisfied.

In one embodiment, the first random access procedure is not initiated when the first PDCCH transmission is received.

In one embodiment, the first random access procedure is initiated when the first PDCCH transmission is received.

In one embodiment, the first random access procedure is being performed when the first PDCCH transmission is received.

In one embodiment, the first PDCCH transmission is received.

In one embodiment, the first PDCCH transmission is not received.

In one embodiment, the first PDCCH transmission is a PDCCH transmission.

In one embodiment, the first PDCCH transmission is a piece of Downlink Control Information (DCI).

In one embodiment, the first PDCCH transmission is a DCI received on the first PDCCH.

In one embodiment, the first PDCCH transmission is a physical layer signal.

In one embodiment, the first PDCCH transmission is in DCI format 1_0.

In one embodiment, the first PDCCH transmission is in DCI format 1_1.

In one embodiment, the first PDCCH transmission is in DCI format 1_2.

In one embodiment, the first PDCCH transmission comprises scheduling information used for new data transmission, the scheduling information comprising at least one of a time-domain location, a frequency-domain location, a Modulation and Coding Scheme (MCS), a Redundancy Version (RV), a New Data Indicator (NDI), or a HARQ process number.

In one embodiment, the first PDCCH transmission comprises HARQ information.

In one embodiment, the first PDCCH transmission comprises an NDI field, the value of the NDI field being toggled.

In one embodiment, the first PDCCH transmission is triggered by a second BFR MAC CE, the second BFR MAC CE including beam failure information for the first RS resource group.

In one embodiment, a process used to receive the first PDCCH transmission is a HARQ process used to transmit the second BFR MAC CE.

In one embodiment, the phrase the first PDCCH transmission being associated with a first identifier of the first node comprises: the first PDCCH transmission being scrambled by the first identifier of the first node.

In one embodiment, the phrase the first PDCCH transmission being associated with a first identifier of the first node comprises: the first PDCCH transmission being received by listening into the first identifier of the first node.

In one embodiment, the phrase the first PDCCH transmission being associated with a first identifier of the first node comprises: the first PDCCH transmission being addressed to the first identifier of the first node.

In one embodiment, the first identifier of the first node is an identifier of the first node in the first cell.

In one embodiment, the first identifier of the first node is an identifier of the first node in the second cell.

In one embodiment, the first identifier of the first node is a C-RNTI of the first node in the first cell.

In one embodiment, the first identifier of the first node is a C-RNTI of the first node in the second cell.

In one embodiment, the first identifier of the first node includes a Cell Radio Network Temporary Identity (C-RNTI) of the first node.

In one embodiment, the first identifier of the first node includes a Modulation and coding scheme C-RNTI (MCS-C-RNTI) of the first node.

In one embodiment, the first identifier of the first node includes a Configured Scheduling RNTI (CS-RNTI) of the first node.

In one embodiment, the first identifier of the first node includes a Sidelink RNTI (SL-RNTI) of the first node.

In one embodiment, the first identifier of the first node includes a Sidelink Configured Scheduling RNTI (SLCS-RNTI) of the first node.

In one embodiment, the first identifier of the first node is not a Temporary C-RNTI (TC-RNTI).

In one embodiment, the phrase the first PDCCH transmission indicating a first uplink grant comprises that the first uplink grant is an uplink grant received on the first PDCCH.

In one embodiment, the phrase the first PDCCH transmission indicating a first uplink grant comprises that the first PDCCH transmission is used to determine the first uplink grant.

In one embodiment, the first uplink grant is used for a PUSCH (i.e., Physical uplink shared channel) transmission.

In one embodiment, the first uplink grant is an uplink (UL) grant.

In one embodiment, the first uplink grant is an uplink resource being used for PUSCH transmission.

In one embodiment, the first uplink grant comprises at least one of a time-domain resource, a frequency-domain resource, a code-domain resource, or a spatial-domain resource.

In one embodiment, the second BFR MAC CE in this application is an R17 enhanced BFR MAC CE.

In one embodiment, the second BFR MAC CE in this application is used for beam failure recovery.

In one embodiment, a MAC CE format to which the second BFR MAC CE of the present application belongs can be used to indicate at least one of the first RS resource group or the second RS resource group.

In one embodiment, the second BFR MAC CE in the present application is a MAC CE carrying beam failure information for the first RS resource group.

In one embodiment, the second BFR MAC CE in the present application is a MAC CE indicating a beam failure against the first RS resource group.

In one embodiment, the second BFR MAC CE corresponds to one LCID (i.e., Logical Channel ID) Index, the one LCID Index corresponding to one LCID Codepoint; the one LCID Index is not equal to 50 (the one LCID Codepoint is not equal to 50), and, the one LCID Index is not equal to 51 (the one LCID Codepoint is not equal to 51).

In one embodiment, the second BFR MAC CE corresponds to one eLCID (i.e., extended LCID) Index, the one eLCID Index corresponding to one eLCID Codepoint; the one eLCID Index is not equal to 314 (the one eLCID Codepoint is not equal to 250), and, the one eLCID Index is not equal to 315 (the one eLCID Codepoint is not equal to 251).

In one embodiment, the second BFR MAC CE corresponds to one LCID Index, the one LCID Index corresponding to one LCID Codepoint; the one LCID Index is equal to 50 (the one LCID Codepoint is not equal to 50), or, the one LCID Index is equal to 51 (the one LCID Codepoint is not equal to 51).

In one embodiment, the second BFR MAC CE corresponds to one eLCID Index, the one eLCID Index corresponding to one eLCID Codepoint; the one eLCID Index is equal to 314 (the one eLCID Codepoint is not equal to 250), or, the one eLCID Index is equal to 315 (the one eLCID Codepoint is not equal to 251).

In one embodiment, the second BFR MAC CE in the present application is a MAC CE, the one MAC CE comprising at least one bitmap, with at least one bit in the at least one bitmap indicating that a beam failure against the first RS resource group is detected and an evaluation of candidate beams for the first RS resource group has been completed.

In one embodiment, the second BFR MAC CE in the present application is a MAC CE, the one MAC CE comprising at least one piece of BFR information, one of the at least one piece of BFR information being the BFR information for the first RS resource group.

In one embodiment, the second BFR MAC CE in the present application is a MAC CE, the one MAC CE comprising at least one bitmap and at least one piece of BFR information; at least one bit in the at least one bitmap indicates that a beam failure against the first RS resource group is detected and an evaluation of candidate beams for the first RS resource group has been completed; one of the at least one piece of BFR information is the BFR information for the first RS resource group.

In one embodiment, the first uplink grant is not associated with the first identifier of the first node, and the value of an NDI in the first PDCCH transmission has been toggled compared to a previous transmission on the HARQ process.

In one embodiment, the phrase the first uplink grant being used for new data transmission comprises: the first uplink grant being used for a new transmission.

In one embodiment, the phrase the first uplink grant being used for new data transmission comprises: the first uplink grant being not used for retransmission.

In one embodiment, the phrase the first uplink grant being used for new data transmission comprises: the first uplink grant being used for transmitting a new Transmission Block (TB).

In one embodiment, as a response to the first PDCCH transmission being received, it is determined that the second condition is satisfied.

In one embodiment, the second condition being satisfied means that the first PDCCH transmission is received.

In one embodiment, the first BFR is a BFR associated with the first RS resource group.

In one embodiment, the first BFR belongs to the first RS resource group.

In one embodiment, the first BFR is associated with the first RS resource group.

In one embodiment, whether the first BFR is triggered is dependent on the first counter.

In one embodiment, the first BFR does not belong to the second RS resource group.

In one embodiment, the first BFR is associated with the second RS resource group.

In one embodiment, whether the first BFR is triggered is not dependent on the second counter.

In one embodiment, the first threshold and the second threshold are equal.

In one embodiment, the first threshold and the second threshold are not equal.

In one embodiment, the first threshold and the second threshold have the same units.

In one embodiment, the first threshold and the second threshold are configured in different RRC messages.

In one embodiment, the first threshold and the second threshold are configured in different RRC fields of a same RRC message.

In one embodiment, the first threshold is pre-configured.

In one embodiment, the first threshold is configured via an RRC message.

In one embodiment, the first threshold includes a Block Error Ratio (BLER) threshold.

In one embodiment, the first threshold includes an RSRP threshold.

In one embodiment, the first threshold comprises Qₒᵤₜ.

In one embodiment, the first threshold is indicated by a field in an RRC message.

In one embodiment, the first threshold is indicated by a field in an RRC message, where a name of the field includes rlmInSyncOutOfSyncThreshold.

In one embodiment, the first threshold is indicated by a field in an RRC message, where a name of the field includes rsrp-ThresholdSSB.

In one embodiment, the first threshold is indicated by a field in an RRC message, where a name of the field includes rsrp-ThresholdBFR.

In one embodiment, the second threshold is pre-configured.

In one embodiment, the second threshold is configured via an RRC message.

In one embodiment, the second threshold includes a Block Error Ratio (BLER) threshold.

In one embodiment, the second threshold comprises an RSRP threshold.

In one embodiment, the second threshold comprises Qₒᵤₜ.

In one embodiment, the second threshold is indicated by a field in an RRC message.

In one embodiment, the second threshold is indicated by a field in an RRC message, where a name of the field includes rlmInSyncOutOfSyncThreshold.

In one embodiment, the second threshold is indicated by a field in an RRC message, where a name of the field includes rsrp-ThresholdSSB.

In one embodiment, the second threshold is indicated by a field in an RRC message, where a name of the field includes rsrp-ThresholdBFR.

In one embodiment, the first value and the second value are equal.

In one embodiment, the first value and the second value are unequal.

In one embodiment, the first counter reaching the first value means that the first counter reaches the first value when the first counter is incremented by 1.

In one embodiment, the first counter reaching the first value means that the first counter that is incremented by 1 reaches the first value.

In one embodiment, the second counter reaching the second value means that the second counter reaches the second value when the second counter is incremented by 1.

In one embodiment, the second counter reaching the second value means that the second counter that is incremented by 1 reaches the second value.

In one embodiment, the third condition is a candidate condition in the first candidate condition set.

In one embodiment, the third condition is not a candidate condition in the first candidate condition set.

In one embodiment, the third condition comprises that a MAC entity of a cell group to which the first cell belongs is reconfigured.

In one embodiment, a counter associated with the first RS resource group being reconfigured is used to determine that the first counter is set to 0, the counter including at least one of beam or Failure or Detection or Timer in its name.

In one embodiment, the first value being reconfigured is used to determine that the first counter is set to 0.

In one embodiment, any reference signal in the first RS resource group being reconfigured by a higher layer is used to determine that the first counter is set to 0.

In one embodiment, a MAC entity of a cell group to which the first cell belongs being reconfigured is used to determine that the first counter is set to 0.

In one embodiment, the second condition being satisfied is used to determine that the first counter is set to 0.

In one embodiment, any reference signal in the first RS resource group is not reconfigured.

In one embodiment, the counter that is associated with the first RS resource group is not reconfigured.

In one embodiment, the first value is not reconfigured.

In one embodiment, a MAC entity of a cell group to which the first cell belongs is not reconfigured.

In one embodiment, whether to initiate the first random access procedure is related to whether the second random access procedure is being performed.

In one embodiment, whether to initiate the first random access procedure is unrelated to whether the second random access procedure is being performed.

In one embodiment, an evaluation of candidate beams for the first RS resource group refers to determining, based on measurement results, whether there is a candidate beam that satisfies the conditions among at least one candidate beam corresponding to the first RS resource group.

In one embodiment, an evaluation of candidate beams for the second RS resource group refers to determining, based on measurement results, whether there is a candidate beam that satisfies the conditions among at least one candidate beam corresponding to the second RS resource group.

In one embodiment, an evaluation of candidate beams for the first RS resource group refers to determining whether there exists a candidate beam with an RSRP measurement result that is not less than or greater than a pre-configured RSRP threshold among at least one candidate beam corresponding to the first RS resource group.

In one embodiment, an evaluation of candidate beams for the second RS resource group refers to determining whether there exists a candidate beam with an RSRP measurement result that is not less than or greater than a pre-configured RSRP threshold among at least one candidate beam corresponding to the second RS resource group.

In one embodiment, it is determined according to the requests of 3GPP TS 38.133 that the evaluation of the candidate beams for the first RS resource group has been successfully completed.

In one embodiment, it is determined according to the requests of 3GPP TS 38.133 that the evaluation of the candidate beams for the second RS resource group has been successfully completed.

In one embodiment, it is determined that a beam failure against the first RS resource group is detected based on the first counter reaching the first value.

In one embodiment, it is determined that a beam failure against the second RS resource group is detected based on the second counter reaching the second value.

In one embodiment, the one candidate beam corresponds to one candidate RS resource.

In one embodiment, the one candidate beam is determined by one candidate RS resource.

In one embodiment, an enhanced BFR MAC CE is capable of indicating at least one of the first RS resource group or the second RS resource group.

In one embodiment, the first BFR MAC CE in the present application, the second BFR MAC CE in the present application, and the third BFR MAC CE in the present application have the same format.

In one embodiment, at least two of the first BFR MAC CE in this application, the second BFR MAC CE in this application, and the third BFR MAC CE in this application have different formats.

### Embodiment 2

Embodiment 2 illustrates a schematic diagram of a network architecture according to one embodiment of the present application, as shown in FIG. 2. FIG. 2 illustrates a network architecture 200 of 5G New Radio (NR)/Long-Term Evolution (LTE)/Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise UE(s) 201, a RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises a node 203 and another node 204. The node 203 provides UE 201 oriented user plane and control plane terminations. The node 203 can be connected to other node 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a UE.

In one embodiment, the node 203 is a relay.

In one embodiment, the node 203 is a Gateway.

In one embodiment, the node 204 corresponds to the third node in the present application.

In one embodiment, the node 204 corresponds to the fourth node in the present application.

In one embodiment, the node 204 is a base station.

In one embodiment, the node 204 is a UE.

In one embodiment, the node 204 is a relay.

In one embodiment, the node 204 is a Gateway.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE includes a mobile terminal, or the UE includes an aircraft, or the UE includes a vehicle-mounted terminal, or the UE includes a vessel, or the UE includes an IoT terminal, or the UE includes an IIoT terminal, or the UE includes a device supporting low-delay and high-reliability transmission, or the UE includes testing equipment, or the UE includes a signaling test instrument.

In one embodiment, the base station is a BS, or the base station is a Base Transceiver Station (BTS), or the base station is a NodeB (NB), or the base station is a gNB, or the base station is an eNB, or the base station is an ng-eNB, or the base station is an en-gNB.

In one embodiment, the base station includes test equipment, or the base station includes a signaling test instrument, or the base station includes satellite equipment, or the base station includes a flight platform, or the base station includes a Macro Cellular base station, or the base station includes a Micro Cell base station, or the base station includes a Pico Cell base station, or the base station includes a Femtocell.

In one embodiment, the base station supports transmissions in NTN.

In one embodiment, the base station supports transmissions in large-delay-difference networks.

In one embodiment, the base station supports transmissions in TN.

In one embodiment, the base station comprises a base station device supporting large time-delay difference.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are layer1, layer2 and layer3. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the radio protocol architecture in FIG. 3 is applicable to the fourth node in the present application.

In one embodiment, the first signaling in the present application is generated by the RRC 306.

In one embodiment, the first signaling in the present application is generated by the MAC302 or the MAC352.

In one embodiment, the first signaling in the present application is generated by the PHY301 or the PHY351.

In one embodiment, the first SR in the present application is generated by the MAC302 or the MAC352.

In one embodiment, the first SR in the present application is generated by the PHY301 or the PHY351.

In one embodiment, the first BFR in the present application is generated by the MAC302 or the MAC352.

In one embodiment, the first BFR MAC CE in the present application is generated by the MAC302 or the MAC352.

In one embodiment, the first BFR MAC CE in the present application is generated by the PHY301 or the PHY351.

In one embodiment, the second BFR MAC CE in the present application is generated by the MAC302 or the MAC352.

In one embodiment, the second BFR MAC CE in the present application is generated by the PHY301 or the PHY351.

In one embodiment, the third BFR MAC CE in the present application is generated by the MAC302 or the MAC352.

In one embodiment, the third BFR MAC CE in the present application is generated by the PHY301 or the PHY351.

In one embodiment, the first PDCCH transmission in the present application is generated by the PHY301 or the PHY351.

### Embodiment 4

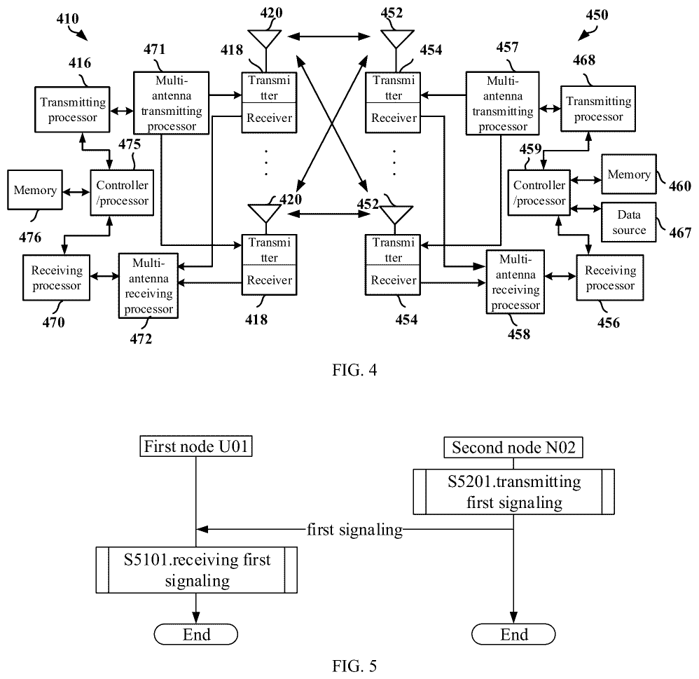

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource; and increments a first counter by 1 whenever a radio link quality evaluated according to the first RS resource group is worse than a first threshold; and increments a second counter by 1 whenever a radio link quality evaluated according to the second RS resource group is worse than a second threshold; and triggers a first BFR as a response to at least the first counter reaching a first value; any condition in a first candidate condition set being satisfied being used to determine cancelling the first BFR; herein, a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, the first communication device 450 comprises a memory that stores a computer readable instruction program. The computer readable instruction program generates actions when executed by at least one processor. The actions include: receiving a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource; and incrementing a first counter by 1 whenever a radio link quality evaluated according to the first RS resource group is worse than a first threshold; and incrementing a second counter by 1 whenever a radio link quality evaluated according to the second RS resource group is worse than a second threshold; and triggering a first BFR as a response to at least the first counter reaching a first value; any condition in a first candidate condition set being satisfied being used to determine cancelling the first BFR; herein, a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource; herein, a first counter is incremented by 1 whenever a radio link quality evaluated according to the first RS resource group is worse than a first threshold; and a second counter is incremented by 1 whenever a radio link quality evaluated according to the second RS resource group is worse than a second threshold; and a first BFR is triggered as a response to at least the first counter reaching a first value; any condition in a first candidate condition set being satisfied is used to determine cancelling of the first BFR; a first condition is a candidate condition in the first candidate condition set, the first condition being related to a first random access procedure; whether the first random access procedure is initiated by a receiver of the first signaling is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the receiver of the first signaling, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, the second communication device 410 comprises a memory that stores a computer readable instruction program. The computer readable instruction program generates actions when executed by at least one processor. The actions include: transmitting a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource; herein, a first counter is incremented by 1 whenever a radio link quality evaluated according to the first RS resource group is worse than a first threshold; and a second counter is incremented by 1 whenever a radio link quality evaluated according to the second RS resource group is worse than a second threshold; and a first BFR is triggered as a response to at least the first counter reaching a first value; any condition in a first candidate condition set being satisfied is used to determine cancelling of the first BFR; a first condition is a candidate condition in the first candidate condition set, the first condition being related to a first random access procedure; whether the first random access procedure is initiated by a receiver of the first signaling is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the receiver of the first signaling, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, the antenna 452, the receiver 454, the receiving processor 456 and the controller/processor 459 are used for receiving a first signaling; at least one of the antenna 420, the transmitter 418, the transmitting processor 416 or the controller/processor 475 is used for transmitting a first signaling.

In one embodiment, the antenna 452, the receiver 454, the receiving processor 456 and the controller/processor 459 are used for receiving a first PDCCH transmission; at least one of the antenna 420, the transmitter 418, the transmitting processor 416 or the controller/processor 475 is used for transmitting a first PDCCH transmission.

In one embodiment, the antenna 452, the transmitter 454, the transmitting processor 468 and the controller/processor 459 are used for transmitting a first BFR MAC CE; at least one of the antenna 420, the receiver 418, the receiving processor 470 or the controller/processor 475 is used for receiving a first BFR MAC CE.

In one embodiment, the antenna 452, the transmitter 454, the transmitting processor 468 and the controller/processor 459 are used for transmitting a second BFR MAC CE; at least one of the antenna 420, the receiver 418, the receiving processor 470 or the controller/processor 475 is used for receiving a second BFR MAC CE.

In one embodiment, the antenna 452, the transmitter 454, the transmitting processor 468 and the controller/processor 459 are used for transmitting a third BFR MAC CE; at least one of the antenna 420, the receiver 418, the receiving processor 470 or the controller/processor 475 is used for receiving a third BFR MAC CE.

In one embodiment, the first communication device 450 corresponds to the first node in the present application.

In one embodiment, the second communication device 410 corresponds to the second node in the present application.

In one embodiment, the second communication device 410 corresponds to the third node in the present application.

In one embodiment, the second communication device 410 corresponds to the fourth node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a first signaling in step S5101.

The second node N02 transmits the first signaling in step S5201.

In Embodiment 5, the first signaling indicates a first RS resource set, the first RS resource set comprising at least a first RS resource group and a second RS resource group, the first RS resource group comprising at least one RS resource, and the second RS resource group comprising at least one RS resource; a first counter is incremented by 1 whenever a radio link quality evaluated according to the first RS resource group is worse than a first threshold; and a second counter is incremented by 1 whenever a radio link quality evaluated according to the second RS resource group is worse than a second threshold; at least the first counter reaching a first value is used to determine triggering of a first BFR; any condition in a first candidate condition set being satisfied is used to determine cancelling of the first BFR; a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, the first node U01 is a UE.

In one embodiment, the second node N02 is a maintenance base station for a serving cell of the first node.

In one embodiment, the second node N02 is a maintenance base station for the first cell.

In one embodiment, the second node N02 is not a maintenance base station for the second cell.

In one embodiment, the second node N02 is a MN of the first node.

In one embodiment, the second node N02 is a SN of the first node.

In one embodiment, the second node N02 is a base station, and the first node U01 is a UE.

In one embodiment, the second node N02 is a base station, and the first node U01 is a base station.

In one embodiment, the second node N02 is a UE, and the first node U01 is a UE.

### Embodiment 6

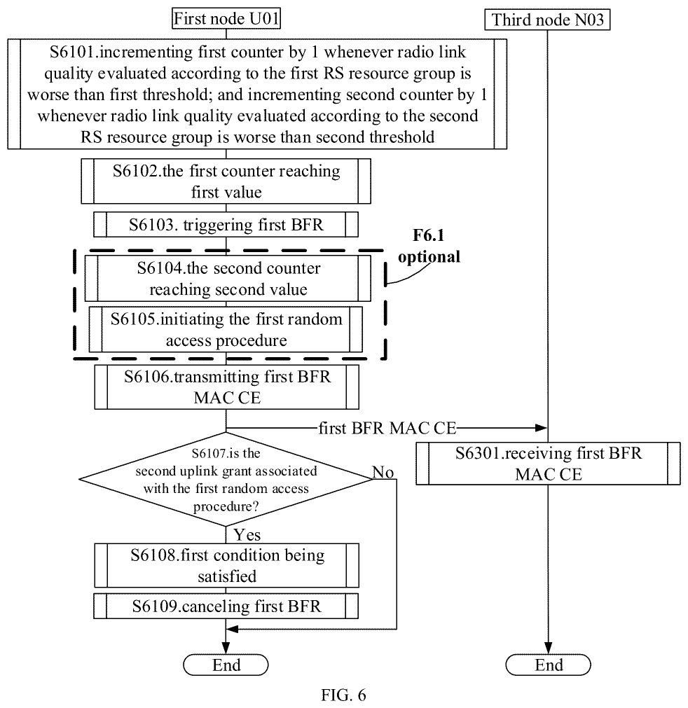

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

The first node U01, in step S6101, increments a first counter by 1 whenever a radio link quality evaluated according to the first RS resource group is worse than a first threshold; and increments a second counter by 1 whenever a radio link quality evaluated according to the second RS resource group is worse than a second threshold; in step S6102, the first counter reaching a first value; and in step S6103, triggers a first BFR as a response to at least the first counter reaching a first value; in step S6104, the second counter reaching a second value; in step S6105, initiates the first random access procedure as a response to at least the first counter reaching the first value and the second counter reaching the second value; in step S6106, transmits a first BFR MAC CE on a second uplink grant; and in step S6107, determines whether the second uplink grant is associated with the first random access procedure as a response to the first BFR MAC CE being transmitted on the second uplink grant; if the second uplink grant is associated with the first random access procedure, enter into step S6108, if the second uplink grant is not associated with the first random access procedure, skip the step S6108 and step S6109; in the step S6108, the first condition being satisfied; and in the step S6109, cancels the first BFR as a response to the first condition being satisfied.

The third node N03 receives the first BFR MAC CE in step S6201.

In Embodiment 6, whether the first condition is satisfied is determined according to whether the second uplink grant is associated with the first random access procedure as a response to the first BFR MAC CE being transmitted on the second uplink grant; the first signaling indicates the first RS resource set, the first RS resource set comprising at least the first RS resource group and the second RS resource group, the first RS resource group comprising at least one RS resource, and the second RS resource group comprising at least one RS resource, the first RS resource group and the second RS resource group comprising at least one different RS resource; any condition in a first candidate condition set being satisfied being used to determine cancelling the first BFR; a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, the third node N03 is a maintenance base station for a serving cell of the first node.

In one embodiment, the third node N03 is a maintenance base station for the first cell.

In one embodiment, the third node N03 is a maintenance base station for the second cell.

In one embodiment, the third node N03 is a Master Node (MN) of the first node.

In one embodiment, the third node N03 is a Secondary Node (SN) of the first node.

In one embodiment, the third node N03 is a maintenance base station for a SpCell.

In one embodiment, the third node N03 is a maintenance base station for an SCell.

In one embodiment, the third node N03 is identical to the second node N02.

In one embodiment, the third node N03 is different from the second node N02.

In one embodiment, the first BFR MAC CE in this application is used for beam failure recovery.

In one embodiment, the first BFR MAC CE in this application is an R17 enhanced BFR MAC CE.

In one embodiment, a MAC CE format to which the first BFR MAC CE of the present application belongs can be used to indicate at least one of the first RS resource group or the second RS resource group.

In one embodiment, the first BFR MAC CE indicates that at least a beam failure against the first RS resource group is detected.

In one embodiment, the first BFR MAC CE indicates that a beam failure against the second RS resource group is detected.

In one embodiment, the first BFR MAC CE indicates that a beam failure against the first RS resource group is detected and that a beam failure against the second RS resource group is detected.

In one embodiment, the first BFR MAC CE corresponds to one LCID Index, the one LCID Index corresponds to one LCID Codepoint; the one LCID Index is not equal to 50 (the one LCID Codepoint is not equal to 50), and, the one LCID Index is not equal to 51 (the one LCID Codepoint is not equal to 51).

In one embodiment, the first BFR MAC CE corresponds to one eLCID Index, the one eLCID Index corresponds to one eLCID Codepoint; the one eLCID Index is not equal to 314 (the one eLCID Codepoint is not equal to 250), and, the one eLCID Index is not equal to 315 (the one eLCID Codepoint is not equal to 251).

In one embodiment, the first BFR MAC CE corresponds to one LCID Index, the one LCID Index corresponds to one LCID Codepoint; the one LCID Index is equal to 50 (the one LCID Codepoint is not equal to 50), or, the one LCID Index is equal to 51 (the one LCID Codepoint is not equal to 51).

In one embodiment, the first BFR MAC CE corresponds to one eLCID Index, the one eLCID Index corresponds to one eLCID Codepoint; the one eLCID Index is equal to 314 (the one eLCID Codepoint is not equal to 250), or, the one eLCID Index is equal to 315 (the one eLCID Codepoint is not equal to 251).

In one embodiment, the first BFR MAC CE in the present application is a MAC CE, the one MAC CE comprising at least one bitmap, with at least one bit in the at least one bitmap indicating that a beam failure against the first RS resource group is detected and an evaluation of candidate beams for the first RS resource group has been completed.

In one embodiment, the first BFR MAC CE in the present application is a MAC CE, the one MAC CE comprising at least one piece of BFR information, one of the at least one piece of BFR information being the BFR information for the first RS resource group.

In one embodiment, the first BFR MAC CE in the present application is a MAC CE, the one MAC CE comprising at least one bitmap and at least one piece of BFR information; at least one bit in the at least one bitmap indicates that a beam failure against the first RS resource group is detected and an evaluation of candidate beams for the first RS resource group has been completed; one of the at least one piece of BFR information is the BFR information for the first RS resource group.

In one embodiment, the second uplink grant is a UL grant.

In one embodiment, the second uplink grant is received in a MAC Random Access Response (RAR) of the first random access procedure.

In one embodiment, the second uplink grant is received in a fallbackRAR of the first random access procedure.

In one embodiment, the second uplink grant is determined based on a PUSCH resource of a Message A (MSGA) associated with the first random access procedure.

In one embodiment, the second uplink grant is dynamically received on a PDCCH.

In one embodiment, the second uplink grant is configured semi-persistently via an RRC message.

In one embodiment, the second uplink grant is capable of accommodating the first BFR MAC CE and a subheader of the first BFR MAC CE.

In one embodiment, as a response to the first BFR MAC CE being transmitted on the second uplink grant, the first condition is satisfied if the second uplink grant is associated with the first random access procedure, and the first condition is not satisfied if the second uplink grant is not associated with the first random access procedure.

In one embodiment, as a response to the first BFR MAC CE being transmitted on the second uplink grant, canceling the first BFR if the second uplink grant is associated with the first random access procedure.

In one embodiment, if the second uplink grant is received in a MAC RAR of the first random access procedure, the second uplink grant is associated with the first random access procedure.

In one embodiment, if the second uplink grant is received in a fallbackRAR of the first random access procedure, the second uplink grant is associated with the first random access procedure.

In one embodiment, if the second uplink grant is determined based on a PUSCH resource of an MSGA associated with the first random access procedure, the second uplink grant is associated with the first random access procedure.

In one embodiment, if the second uplink grant is received in a MAC RAR of the first random access procedure, or, if the second uplink grant is received in a fallbackRAR of the first random access procedure, or, if the second uplink grant is determined based on a PUSCH resource of an MSGA associated with the first random access procedure, the second uplink grant is associated with the first random access procedure.

In one embodiment, if the second uplink grant is dynamically received on a PDCCH and the first random access procedure is being performed when the second uplink grant is received, the second uplink grant is associated with the first random access procedure.

In one embodiment, if the second uplink grant is received in a MAC RAR of the first random access procedure, or, if the second uplink grant is received in a fallbackRAR of the first random access procedure, or, if the second uplink grant is determined based on a PUSCH resource of an MSGA associated with the first random access procedure, or, if the second uplink grant is dynamically received on a PDCCH and the first random access procedure is being performed when the second uplink grant is received, the second uplink grant is associated with the first random access procedure.

In one embodiment, if the second uplink grant is dynamically received on a PDCCH, the second uplink grant is not associated with the first random access procedure.

In one embodiment, if the second uplink grant is dynamically received on a PDCCH and the first random access procedure is not being performed when the second uplink grant is received, the second uplink grant is not associated with the first random access procedure.

In one embodiment, if the second uplink grant is configured semi-persistently via an RRC message, the second uplink grant is not associated with the first random access procedure.

In one embodiment, as a response to the first BFR MAC CE being transmitted on the second uplink grant, canceling the first BFR if the second uplink grant is associated with the first random access procedure.

In one embodiment, as a response to the first BFR MAC CE being transmitted on the second uplink grant, canceling the first BFR if the second uplink grant is associated with the first random access procedure.

In one embodiment, the first BFR is triggered when the first random access procedure is initiated.

In one embodiment, the first BFR is triggered and the first BFR is not canceled when the first random access procedure is initiated.

In one embodiment, the first BFR is in a pending state when the first random access procedure is initiated.

In one embodiment, the second BFR MAC CE is not transmitted when the first random access procedure is initiated.

In one embodiment, the second BFR MAC CE is transmitted and the first PDCCH transmission is not received when the first random access procedure is initiated.

In one embodiment, when the first random access procedure is initiated, the second BFR MAC CE is not transmitted, the first SR is transmitted, and an uplink grant for the first SR is not received.

In one embodiment, the first BFR MAC CE is an R17 enhanced BFR MAC CE.

In one embodiment, the dashed-line box F6.1 is optional.

In one embodiment, the dashed-line box F6.1 exists.

In one embodiment, the first random access procedure is being performed when the step S6106 is taken.

In one embodiment, the dashed-line box F6.1 does not exist.

In one embodiment, the first random access procedure is not being performed when the step S6106 is taken.

In one embodiment, a random access procedure being performed comprises that: the random access procedure is initiated, and the random access procedure is not being successfully completed, and no random access problem occurs in the random access procedure.

In one embodiment, a random access procedure being performed comprises that: at least one of ra-ResponseWindow, or msgB-ResponseWindow, or ra-ContentionResolutionTimer for the random access procedure is running.

In one embodiment, a random access procedure being performed comprises that: a PREAMBLE_TRANSMISSION_COUNTER for the random access procedure is smaller than the sum of preambleTransMax and 1.

### Embodiment 7

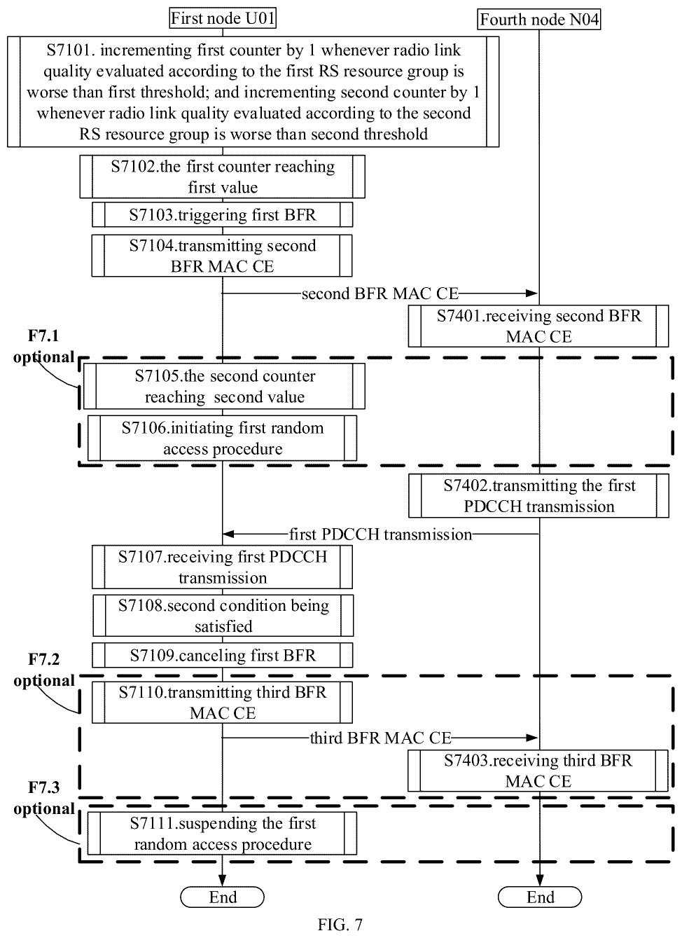

Embodiment 7 illustrates a flowchart of signal transmission according to a third embodiment of the present application, as shown in FIG. 7. It should be particularly noted that the sequence illustrated herein does not set any limit to the signal transmission order or implementation order in the present application.

The first node U01, in step S7101, increments a first counter by 1 whenever a radio link quality evaluated according to the first RS resource group is worse than a first threshold; and increments a second counter by 1 whenever a radio link quality evaluated according to the second RS resource group is worse than a second threshold; in step S7102, the first counter reaching a first value; and in step S7103, triggers a first BFR as a response to at least the first counter reaching a first value; in step S7104, transmits a second BFR MAC CE as a response to the action of triggering a first BFR; in step S7105, the second counter reaching a second value; in step S7106, initiates the first random access procedure as a response to at least the first counter reaching the first value and the second counter reaching the second value; and in step S7107, receives the first PDCCH transmission; in step S7108, the second condition being satisfied as a response to the first PDCCH transmission being received; in step S7109, cancels the first BFR as a response to the second condition being satisfied; in step S7110, transmits a third BFR MAC CE on the first uplink grant as a response to the second condition being satisfied; and in step S7111, suspends the first random access procedure as a response to the second condition being satisfied.

The fourth node N04 receives the second BFR MAC CE in step S7401; transmits the first PDCCH transmission in step S7402; and receives the third BFR MAC CE in step S7403.

In one embodiment, the fourth node N04 is a maintenance base station for a serving cell of the first node.

In one embodiment, the fourth node N04 is a maintenance base station for the first cell.

In one embodiment, the fourth node N04 is a maintenance base station for the second cell.

In one embodiment, the fourth node N04 is a MN of the first node.

In one embodiment, the fourth node N04 is a SN of the first node.

In one embodiment, the fourth node N04 is a maintenance base station for a SpCell.

In one embodiment, the fourth node N04 is a maintenance base station for an SCell.

In one embodiment, the fourth node N04 is the same as the second node N02.

In one embodiment, the fourth node N04 is different from the second node N02.

In one embodiment, after the first BFR has been triggered, the second BFR MAC CE is transmitted, the second BFR MAC CE indicating that a beam failure against the first RS resource group is detected and that an evaluation of candidate beams for the first RS resource group has been completed.

In one subembodiment, the second BFR MAC CE indicates that a beam failure against the second RS resource group has not been detected or that the evaluation of a candidate beam for the first RS resource group has not been completed.

In one subembodiment, the second BFR MAC CE does not indicate that a beam failure against the second RS resource group is detected.

In one embodiment, after the first BFR is triggered, the second BFR MAC CE is transmitted, the second BFR MAC CE comprises beam failure recovery information (BFR information) for the first RS resource group, and the second BFR MAC CE does not comprise BFR information for the second RS resource group.

In one embodiment, the first RS resource group is indicated in the second BFR MAC CE and the second RS resource group is not indicated in the second BFR MAC CE.

In one embodiment, that a beam failure against the first RS resource group is detected is indicated in the second BFR MAC CE, and that a beam failure against the second RS resource group is detected is not indicated in the second BFR MAC.

In one embodiment, when the second BFR MAC CE is generated, the second BFR is not triggered for the second RS resource group.

In one embodiment, when the second BFR MAC CE is generated, no beam failure is detected against the second RS resource group.

In one embodiment, when the second BFR MAC CE is generated, a beam failure against the second RS resource group is detected, but an evaluation of candidate beams associated with the second RS resource group is not completed.

In one embodiment, the first random access procedure is initiated when the second condition is satisfied.

In one embodiment, the first random access procedure is not initiated when the second condition is satisfied.

In one embodiment, the first BFR is canceled as a response to the first PDCCH transmission being received.

In one embodiment, the first PDCCH transmission is a response to the second BFR MAC CE.

In one embodiment, the first PDCCH transmission is received as a response to the second BFR MAC CE being transmitted.

In one embodiment, the first PDCCH is received on a HARQ process being used to transmit the second BFR MAC CE.

In one embodiment, as a response to the first PDCCH transmission being received, the first random access procedure is suspended if the first random access procedure is being performed; as a response to the action of triggering a first BFR, a second BFR MAC CE is transmitted; and the second BFR MAC CE is used to trigger the first PDCCH transmission.

In one embodiment, as a response to the first PDCCH transmission being received, a beam failure recovery procedure for the first RS resource group is considered to have been successfully completed and the first BFR is canceled.

In one embodiment, the sentence “suspends the first random access procedure as a response to the second condition being satisfied” can be replaced with: suspends the first random access procedure as a response to the first PDCCH transmission being received.

In one embodiment, the third BFR MAC CE in this application is used for beam failure recovery.

In one embodiment, the third BFR MAC CE in this application is an R17 enhanced BFR MAC CE.

In one embodiment, a MAC CE format to which the third BFR MAC CE of the present application belongs can be used to indicate at least one of the first RS resource group or the second RS resource group.

In one embodiment, the second RS resource group is indicated in the third BFR MAC CE.

In one embodiment, that a beam failure against the second RS resource group is detected is indicated in the third BFR MAC CE.

In one embodiment, the third BFR MAC CE corresponds to one LCID Index, the one LCID Index corresponds to one LCID Codepoint; the one LCID Index is not equal to 50 (the one LCID Codepoint is not equal to 50), and, the one LCID Index is not equal to 51 (the one LCID Codepoint is not equal to 51).

In one embodiment, the third BFR MAC CE corresponds to one eLCID Index, the one eLCID Index corresponds to one eLCID Codepoint; the one eLCID Index is not equal to 314 (the one eLCID Codepoint is not equal to 250), and, the one eLCID Index is not equal to 315 (the one eLCID Codepoint is not equal to 251).

In one embodiment, the third BFR MAC CE corresponds to one LCID Index, the one LCID Index corresponds to one LCID Codepoint; the one LCID Index is equal to 50 (the one LCID Codepoint is not equal to 50), or, the one LCID Index is equal to 51 (the one LCID Codepoint is not equal to 51).

In one embodiment, the third BFR MAC CE corresponds to one eLCID Index, the one eLCID Index corresponds to one eLCID Codepoint; the one eLCID Index is equal to 314 (the one eLCID Codepoint is not equal to 250), or, the one eLCID Index is equal to 315 (the one eLCID Codepoint is not equal to 251).

In one embodiment, the third BFR MAC CE in the present application is a MAC CE, the one MAC CE comprising at least one bitmap, with at least one bit in the at least one bitmap indicating that a beam failure against the second RS resource group is detected and an evaluation of candidate beams for the second RS resource group has been completed.

In one embodiment, the third BFR MAC CE in the present application is a MAC CE, the one MAC CE comprising at least one piece of BFR information, one of the at least one piece of BFR information being the BFR information for the second RS resource group.

In one embodiment, the third BFR MAC CE in the present application is a MAC CE, the one MAC CE comprising at least one bitmap and at least one piece of BFR information; at least one bit in the at least one bitmap indicates that a beam failure against the second RS resource group is detected and an evaluation of candidate beams for the second RS resource group has been completed; one of the at least one piece of BFR information is the BFR information for the second RS resource group.

In one embodiment, the sentence “transmits a third BFR MAC CE on the first uplink grant as a response to the second condition being satisfied” can be replaced with: transmits a third BFR MAC CE on the first uplink grant as a response to the first PDCCH transmission being received.

In one embodiment, if the first uplink grant indicated by the first PDCCH transmission is capable of accommodating the third BFR MAC CE and a subheader of the third BFR MAC CE, the third BFR MAC CE is generated.

In one embodiment, as a response to the first PDCCH transmission being received, the first PDCCH is used to determine that a beam failure recovery for the first RS resource group is successfully completed if a MAC Protocol Data Unit (PDU) is included in a Msg3 buffer of the first random access procedure, in response to the first PDCCH transmission being received, the MAC PDU is obtained from the Msg3 buffer and the MAC PDU is transmitted on the first uplink grant; where the MAC PDU includes the third BFR MAC CE.

In one embodiment, the first uplink grant is capable of accommodating the MAC PDU.

In one embodiment, as a response to the second condition being satisfied, generating the third BFR MAC CE and transmitting the third BFR MAC CE.

In one embodiment, the first uplink grant is capable of accommodating the third BFR MAC CE and a subheader of the third BFR MAC CE.

In one embodiment, the receiver of the second BFR MAC CE and the receiver of the third BFR MAC CE may be two different nodes.

In one subembodiment, the first PDCCH transmission is used for cross-carrier scheduling.

In one subembodiment, the receiver of the second BFR MAC CE and the receiver of the third BFR MAC CE are maintenance base stations for two different cells in a same cell group, respectively.

In one embodiment, as a response to the second condition being satisfied, the first counter is set to 0.

In one embodiment, when the first PDCCH is received, a beam failure recovery for the second RS resource group is not successfully completed.

In one embodiment, when the first PDCCH is received, a beam failure against the second RS resource group is detected and an evaluation of candidate beams for the second RS resource group has been successfully completed.

In one embodiment, the dashed-line box F7.1 is optional.

In one embodiment, the dashed-line box F7.1 exists.

In one embodiment, the dashed-line box F7.1 does not exist.

In one embodiment, the dashed-line box F7.2 is optional.

In one embodiment, the dashed-line box F7.2 exists.

In one embodiment, the dashed-line box F7.2 does not exist.

In one embodiment, the dashed-line box F7.3 is optional.

In one embodiment, the dashed-line box F7.3 exists.

In one embodiment, the dashed-line box F7.3 does not exist.

In one embodiment, all of the dashed-line box F7.1, the dashed-line box F7.2 and the dashed-line box F7.3 exist.

In one embodiment, none of the dashed-line box F7.1, the dashed-line box F7.2 and the dashed-line box F7.3 exists.

In one embodiment, the dashed-line box F7.1 exists, and the dashed-line box F7.3 exists.

In one embodiment, the dashed-line box F7.1 exists, while the dashed-line box F7.3 does not exist.

In one embodiment, the dashed-line box F7.1 exists, while the dashed-line boxes F7.2 and F7.3 do not exist.

In one embodiment, the dashed-line boxes F7.1 and F7.2 exist, while the dashed-line boxes F7.3 does not exist.

In one embodiment, the dashed-line boxes F7.1 and F7.3 exist, while the dashed-line boxes F7.2 does not exist.

In one embodiment, the step S7104 is before the step S7106.

In one embodiment, the step S7104 is after the step S7106.

In one embodiment, the order of implementation of the step S7109, the step S7110 and the step S7111 is not limited to the order of implementation shown in the FIG. 7 of the accompanying drawings.

In one embodiment, the order of implementation of the step S7109, the step S7110 and the step S7111 may be interchangeable.

In one embodiment, the first random access procedure is not initiated when the first PDCCH transmission is received.

In one embodiment, the first random access procedure is not completed when the first PDCCH transmission is received.

In one embodiment, the first random access procedure has been completed when the first PDCCH transmission is received.

In one embodiment, the first PDCCH is monitored during the performance of the first random access procedure.

In one embodiment, the first PDCCH is not monitored during the performance of the first random access procedure.

### Embodiment 8

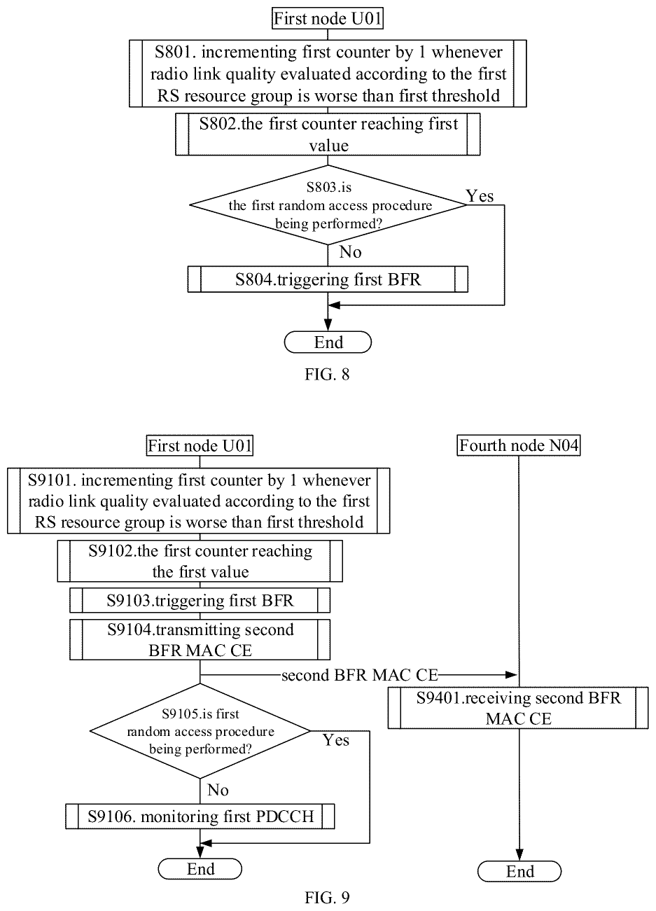

Embodiment 8 illustrates a schematic diagram of a first random access procedure not being performed being used to determine triggering of a first BFR according to one embodiment of the present application, as shown in FIG. 8. It should be particularly noted that the sequence illustrated herein does not set any limit to the signal transmission order or implementation order in the present application.

The first node U01 increments a first counter by 1 whenever a radio link quality evaluated according to the first RS resource group is worse than a first threshold in step S801; the first counter reaching a first value in step S802; and determines whether the first random access procedure is being performed in step S803; if the first random access procedure is not being performed, enter into step S804, if the first random access procedure is being performed, skip step S804; and triggers the first BFR in step S804.

In Embodiment 8, as a response to the first counter reaching the first value, the first random access procedure not being performed is used to determine triggering of the first BFR.

In one embodiment, as a response to the first counter reaching a first value, whether the first BFR is triggered is related to whether the first random access procedure is being performed.

In one embodiment, as a response to the first counter reaching a first value, whether the first random access procedure is being performed is used to determine whether to trigger the first BFR.

In one embodiment, as a response to the first counter reaching the first value, the first BFR is triggered if the first random access procedure is not being performed, and the first BFR is not triggered if the first random access procedure is being performed.

In one embodiment, the first counter reaching the first value and the first random access procedure not being performed is used to determine the triggering of the first BFR.

In one embodiment, as a response to the action of incrementing the first counter by 1, the first BFR is triggered if the first counter reaches the first value and the first random access procedure is not being performed.

In one embodiment, if the first counter reaches the first value and the first random access procedure is not being performed, the first BFR is triggered.

In one embodiment, if the first counter reaches the first value and the first random access procedure is being performed, the first BFR is not triggered.

In one embodiment, the action “triggering a first BFR as a response to at least the first counter reaching a first value” includes: as a response to the first counter reaching the first value, if the first random access procedure is not being performed, triggering the first BFR.

In one embodiment, the action “triggering a first BFR as a response to at least the first counter reaching a first value” includes: as a response to the first counter reaching the first value, if the first random access procedure is not being performed, and, the second BFR is not triggered or the second BFR is not in a pending state, triggering the first BFR.

In one embodiment, the first BFR is not triggered during the performance of the first random access procedure.

In one embodiment, the first BFR is not triggered during the performance of the first random access procedure if the first counter reaches the first value.

### Embodiment 9

Embodiment 9 illustrates a schematic diagram of determining whether to monitor a first PDCCH according to whether a first random access procedure is being performed according to one embodiment of the present application, as shown in FIG. 9. It should be particularly noted that the sequence illustrated herein does not set any limit to the signal transmission order or implementation order in the present application.

The first node U01 increments a first counter by 1 whenever a radio link quality evaluated according to the first RS resource group is worse than a first threshold in step S9101; the first counter reaching the first value in step S9102; and triggers a first BFR as a response to at least the first counter reaching the first value in step S9103; transmits a second BFR MAC CE as a response to the action of triggering a first BFR in step S9104; and determines whether a first random access procedure is being performed as a response to the action of transmitting a second BFR MAC CE in step S9105; if the first random access procedure is not being performed, enter into step S9106; if the first random access procedure is being performed, skip step S9106; and monitors the first PDCCH in step S9106.

The second node N04 receives the second BFR MAC CE in step S9401.

In Embodiment 9, determining whether to monitor a first PDCCH according to whether a first random access procedure is being performed as a response to the action of transmitting a second BFR MAC CE; and not monitoring the first PDCCH if the first random access procedure is being performed.

In one embodiment, the action of determining whether to monitor a first PDCCH according to whether a first random access procedure is being performed comprises: monitoring the first PDCCH if the first random access procedure is not being performed; and not monitoring the first PDCCH if the first random access procedure is being performed.

In one embodiment, the action of determining whether to monitor a first PDCCH according to whether a first random access procedure is being performed comprises: monitoring the first PDCCH if the first random access procedure is not being performed; and stopping monitoring the first PDCCH during monitoring of the first PDCCH when the first random access procedure is initiated.

In one embodiment, the phrase determining whether to monitor a first PDCCH according to whether a first random access procedure is being performed means: whether to monitor the first PDCCH is related to whether the first random access procedure is being performed.

In one embodiment, when the first random access procedure is initiated, stop monitoring the first PDCCH if the second BFR MAC CE is transmitted and the first PDCCH is being monitored; the action of stopping monitoring the first PDCCH is used to determine “not monitoring the first PDCCH if the first random access procedure is being performed”.

In one embodiment, when the first random access procedure is initiated, cancel the first BFR if the first BFR is triggered and not canceled; the action of canceling the first BFR is used to determine “not monitoring the first PDCCH if the first random access procedure is being performed”.

In one embodiment, the first PDCCH is not monitored during the time while the first random access procedure is performed.

In one embodiment, as a response to the action of transmitting a second BFR MAC CE, the first PDCCH is monitored if the first random access procedure is not being performed.

In one embodiment, the action of “not monitoring the first PDCCH if the first random access procedure is being performed” comprises: stopping monitoring the first PDCCH when the first random access procedure is initiated.

In one embodiment, the first random access procedure is not being performed when the first BFR is triggered.

In one embodiment, the first random access procedure is not being performed when the second BFR MAC CE is transmitted.

In one embodiment, the first random access procedure is not being performed when the second BFR MAC CE is generated.

In one embodiment, as a response to the action of triggering the first BFR, a given condition being satisfied is used to determine generation of the second BFR MAC CE.

In one embodiment, if the first BFR is not canceled and for the first BFR evaluation of the candidate beams has been completed, and the UL-SCH resources are available for a new transmission, and as a result of LCP, the UL-SCH resources can accommodate the second BFR MAC CE and a subheader of the second BFR MAC CE, the given condition is satisfied.

In one embodiment, if the first BFR is not canceled and for the first BFR evaluation of the candidate beams has been completed, and the UL-SCH resources are available for a new transmission, and as a result of LCP, the UL-SCH resources can accommodate the second BFR MAC CE and a subheader of the second BFR MAC CE, and the first random access procedure is not being performed, then the given condition is satisfied.

In one embodiment, the given condition comprises that at least the first random access procedure is not being performed.

In one embodiment, the second BFR MAC CE is generated only when the given condition is satisfied.

In one embodiment, the first PDCCH comprises at least one PDCCH candidate.

In one embodiment, the first PDCCH is a PDCCH candidate.

In one embodiment, the first PDCCH is a PDCCH.

In one embodiment, the first PDCCH is a PDCCH associated with a C-RNTI of the first node.

In one embodiment, the first PDCCH refers to a PDCCH.

In one embodiment, the first PDCCH is associated with the first PDCCH transmission.

In one embodiment, the first PDCCH is used to monitor and receive the first PDCCH transmission.

In one embodiment, the first PDCCH is associated with a ControlResourceSet (CORESET).

In one embodiment, the first PDCCH is associated with a SearchSpace.

In one embodiment, the first PDCCH comprises a Common search space (CSS).

In one embodiment, the first PDCCH comprises a UE-specific search space (USS).

In one embodiment, the first PDCCH is associated with a BWP.

In one embodiment, the action of monitoring the first PDCCH includes: determining whether the first PDCCH transmission is present by means of energy detection.

In one embodiment, the action of monitoring the first PDCCH includes: determining whether the first PDCCH transmission is present by means of maximum-likelihood testing.

In one embodiment, the action of monitoring the first PDCCH includes: determining whether the first PDCCH transmission is present by means of coherent detection.

In one embodiment, the action of monitoring the first PDCCH includes: detecting on the first PDCCH the presence of a PDCCH transmission scrambled by the first identifier of the first node.

In one embodiment, the action of monitoring the first PDCCH includes: determining whether the first PDCCH transmission is present by means of Cyclic Redundancy Check (CRC).

In one embodiment, the action of monitoring the first PDCCH includes: determining whether a PDCCH transmission exists on the first PDCCH.

In one embodiment, the action of monitoring the first PDCCH includes: determining whether a DCI exists on the first PDCCH.

In one embodiment, the action of monitoring the first PDCCH includes: determining whether a DCI exists on the first PDCCH.

### Embodiment 10

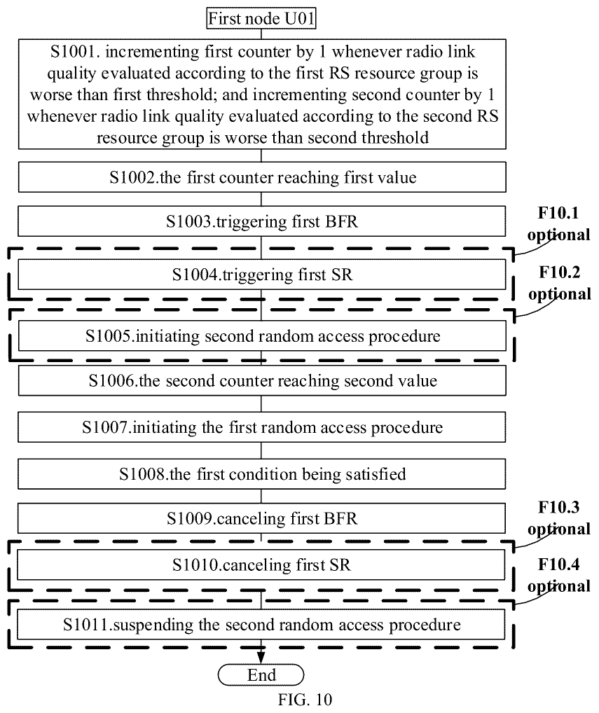

Embodiment 10 illustrates a schematic diagram of a first random access procedure being initiated being used to determine that a first condition is satisfied according to one embodiment of the present application, as shown in FIG. 10. It should be particularly noted that the sequence illustrated herein does not set any limit to the signal transmission order or implementation order in the present application.

The first node U01, in step S1001, increments a first counter by 1 whenever a radio link quality evaluated according to the first RS resource group is worse than a first threshold; and increments a second counter by 1 whenever a radio link quality evaluated according to the second RS resource group is worse than a second threshold; in step S1002, the first counter reaching a first value; and in step S1003, triggers a first BFR as a response to at least the first counter reaching the first value; in step S1004, triggers a first SR as a response to the action of triggering a first BFR; and in step S1005, initiates a second random access procedure as a response to the action of triggering a first SR; in step S1006, the second counter reaching a second value; in step S1007, initiates the first random access procedure as a response to at least the first counter reaching the first value and the second counter reaching the second value; in step S1008, the first condition being satisfied as a response to the first random access procedure being initiated; and in step S1009, cancels the first BFR as a response to the first condition being satisfied; in step S1010, cancels the first SR as a response to the first condition being satisfied, if the first SR is in a pending state; and in step S1011, suspends the second random access procedure as a response to the first condition being satisfied if the second random access procedure is being performed.

In Embodiment 10, initiating the first random access procedure as a response to at least the first counter reaching the first value and the second counter reaching the second value; the first condition being satisfied as a response to the first random access procedure being initiated; and canceling the first BFR as a response to the first condition being satisfied.

In one embodiment, triggering a first SR as a response to the action of triggering a first BFR; and, if the first SR is in a pending state, canceling the first SR as a response to the first condition being satisfied.

Triggering a first SR as a response to the action of triggering a first BFR; and initiating a second random access procedure as a response to the action of triggering a first SR; and suspending the second random access procedure as a response to the first condition being satisfied if the second random access procedure is being performed.

In one embodiment, canceling the first BFR as a response to the first random access procedure being initiated.

In one embodiment, as a response to the first random access procedure being initiated, canceling the first SR if the first SR is in a pending state.

In one embodiment, as a response to the first random access procedure being initiated, suspending the second random access procedure if the second random access procedure is being performed.

In one embodiment, the first SR is triggered.

In one embodiment, the first SR is not triggered.

In one embodiment, triggering a first SR as a response to the action of triggering a first BFR if the given condition is not satisfied.

In one embodiment, if the first BFR is not canceled and an evaluation of candidate beams for the first BFR has been completed and the first random access procedure is not being performed, a first SR is triggered if at least one of the following conditions is not satisfied.

A UL-SCH resource is available for new transmission;

as a result of LCP, the UL-SCH resource is capable of accommodating the second BFR MAC CE and a subheader of the second BFR MAC CE.

In one embodiment, if the first BFR is not canceled and an evaluation of candidate beams for the first BFR has been completed, a first SR is triggered if at least one of the following conditions is not satisfied.

A UL-SCH resource is available for new transmission;

as a result of LCP, the UL-SCH resource is capable of accommodating the second BFR MAC CE and a subheader of the second BFR MAC CE.

In one embodiment, the second random access procedure is initiated.

In one embodiment, the second random access procedure is not initiated.

In one embodiment, the dashed-line box F10.1 is optional.

In one embodiment, the dashed-line box F10.1 exists.

In one embodiment, the dashed-line box F10.1 does not exist.

In one embodiment, the dashed-line box F10.2 is optional.

In one embodiment, the dashed-line box F10.2 exists.

In one embodiment, the dashed-line box F10.2 does not exist.

In one embodiment, the dashed-line box F10.3 is optional.

In one embodiment, the dashed-line box F10.3 exists.

In one embodiment, the dashed-line box F10.3 does not exist.

In one embodiment, the dashed-line box F10.4 is optional.

In one embodiment, the dashed-line box F10.4 exists.

In one embodiment, the dashed-line box F10.4 does not exist.

In one embodiment, the dashed-line box F10.1 exists, and the dashed-line box F10.3 exists.

In one embodiment, the dashed-line box F10.1 exists, while the dashed-line box F10.3 does not exist.

In one embodiment, the dashed-line box F10.1 does not exist, and the dashed-line box F10.3 does not exist.

In one embodiment, the dashed-line box F10.2 exists, and the dashed-line box F10.4 exists.

In one embodiment, the dashed-line box F10.2 exists, while the dashed-line box F10.4 does not exist.

In one embodiment, the dashed-line box F10.2 does not exist, and the dashed-line box F10.4 does not exist.

### Embodiment 11

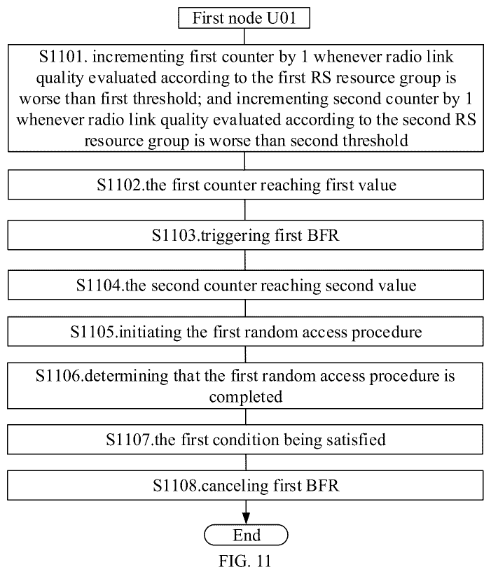

Embodiment 11 illustrates a schematic diagram of a first random access procedure being completed being used to determine that a first condition is satisfied according to one embodiment of the present application, as shown in FIG. 11. It should be particularly noted that the sequence illustrated herein does not set any limit to the signal transmission order or implementation order in the present application.

The first node U01, in step S1101, increments a first counter by 1 whenever a radio link quality evaluated according to the first RS resource group is worse than a first threshold; and increments a second counter by 1 whenever a radio link quality evaluated according to the second RS resource group is worse than a second threshold; in step S1102, the first counter reaching a first value; and in step S1103, triggers a first BFR as a response to at least the first counter reaching the first value; in step S1104, the second counter reaching a second value; in step S1105, initiates the first random access procedure as a response to at least the first counter reaching the first value and the second counter reaching the second value; in step S1106, determines that the first random access procedure is completed; in step S1107, the first condition being satisfied as a response to the action of determining that the first random access procedure is completed; and in step S1108, cancels the first BFR as a response to the first condition being satisfied.

In one embodiment, canceling the first BFR as a response to the action of determining that the first random access procedure is completed.

In one embodiment, having received a PDCCH is used to determine completion of the first random access procedure; the PDCCH is associated with the first identifier of the first node.

In one embodiment, having received a PDCCH is used to determine completion of the first random access procedure; the PDCCH is associated with the first identifier of the first node, the first PDCCH transmission indicating a UL grant used for new data transmission.

In one embodiment, having received a PDCCH is used to determine completion of the first random access procedure; the PDCCH is associated with the first identifier of the first node, and NDI in the first PDCCH transmission is toggled.

In one embodiment, the failure information for the first BFR is not indicated in the first random access procedure.

In one embodiment, the first condition is satisfied as a response to the action of determining that the first random access procedure is completed; where failure information for the first BFR is indicated in the first random access procedure.

In one embodiment, if the failure information for the first BFR is indicated in the first random access procedure, the first BFR is canceled as a response to the action of determining that the first random access procedure is completed.

In one embodiment, the phrase that the failure information for the first BFR is not indicated in the first random access procedure comprises that the second BFR MAC CE is transmitted.

In one embodiment, the phrase that the failure information for the first BFR is not indicated in the first random access procedure comprises that the second BFR MAC CE is generated in the first random access procedure, and the second BFR MAC CE is transmitted in a Msg3 in the first random access procedure.

In one embodiment, the phrase that the failure information for the first BFR is not indicated in the first random access procedure comprises that the second BFR MAC CE is generated in the first random access procedure, the second BFR MAC CE being transmitted in a MSGA in the first random access procedure.

In one embodiment, the phrase that the failure information for the first BFR is not indicated in the first random access procedure comprises that the first random access procedure is completed with a corresponding Preamble associated to the first RS resource group.

In one subembodiment, an SSB or a CSI-RS corresponding to the corresponding Preamble when the first random access procedure is completed belongs to a TRP to which the first RS resource group belongs.

In one subembodiment, an SSB or a CSI-RS corresponding to the corresponding Preamble when the first random access procedure is completed is configured for the first RS resource group.

In one embodiment, the second BFR MAC CE is not transmitted.

### Embodiment 12

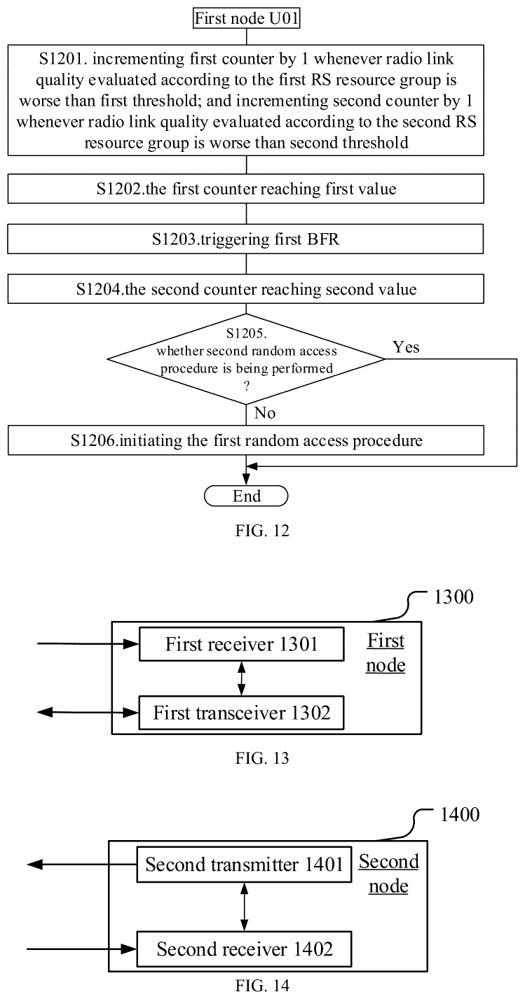

Embodiment 12 illustrates a schematic diagram of determining whether to initiate a first random access procedure according to whether a second random access procedure is being performed according to one embodiment of the present application, as shown in FIG. 12. It should be particularly noted that the sequence illustrated herein does not set any limit to the signal transmission order or implementation order in the present application.

The first node U01, in step S1201, increments a first counter by 1 whenever a radio link quality evaluated according to the first RS resource group is worse than a first threshold; and increments a second counter by 1 whenever a radio link quality evaluated according to the second RS resource group is worse than a second threshold; in step S1202, the first counter reaching a first value; and in step S1203, triggers a first BFR as a response to at least the first counter reaching the first value; in step S1204, the second counter reaching a second value; in step S1205, as a response to at least the first counter reaching the first value and the second counter reaching the second value, determines whether a second random access procedure is being performed, if the second random access procedure is not being performed, enter into step S1206, if the second random access procedure is being performed, skip step S1206; and in step S1206, initiates the first random access procedure.

In Embodiment 12, determining whether to initiate the first random access procedure according to whether a second random access procedure is being performed, as a response to at least the first counter reaching the first value and the second counter reaching the second value; and not initiating the first random access procedure if the second random access procedure is being performed; herein, the second random access procedure is triggered by a first SR, the first SR being triggered by the first BFR.

In one embodiment, whether to initiate the first random access procedure is related to whether at least the first counter reaches the first value and whether the second counter reaches the second value, and whether the second random access procedure is running.

In one embodiment, determining whether to initiate the first random access procedure according to whether a second random access procedure is being performed, as a response to at least the first counter reaching the first value and the second counter reaching the second value; and not initiating the first random access procedure if the second random access procedure is being performed.

In one embodiment, the action of determining whether to initiate the first random access procedure according to whether a second random access procedure is being performed comprises: initiating the first random access procedure if the second random access procedure is not being performed; not initiating the first random access procedure if the second random access procedure is being performed.

In one embodiment, the action of determining whether to initiate the first random access procedure according to whether a second random access procedure is being performed comprises: whether the second random access procedure is being performed being used to determine whether to initiate the first random access procedure.

In one embodiment, whether to initiate the first random access procedure is related to whether the second random access procedure is being performed.

In one embodiment, the first random access procedure is initiated if the first counter reaches the first value and the second counter reaches the second value and the second random access procedure is not being performed.

In one embodiment, the first random access procedure is not initiated if the first counter reaches the first value and the second counter reaches the second value and the second random access procedure is being performed.

In one embodiment, the first random access procedure is not initiated if the second random access procedure is being performed.

In one embodiment, as a response to both the first BFR and the second BFR being triggered, initiating the first random access procedure if the second random access procedure is not being performed.

In one embodiment, as a response to both the first BFR and the second BFR being in a pending state, initiating the first random access procedure if the second random access procedure is not being performed.

In one embodiment, as a response to both the first BFR and the second BFR not being successfully completed, initiating the first random access procedure if the second random access procedure is not being performed.

In one embodiment, as a response to the first BFR being in a pending state and the second BFR being in a pending state, initiating the first random access procedure if the second random access procedure is not being performed.

In one embodiment, as a response to the first BFR not being successfully completed and the second BFR not being successfully completed, initiating the first random access procedure if the second random access procedure is not being performed.

In one embodiment, as a response to at least the first counter reaching the first value and the second counter reaching the second value, if the second random access procedure is not being performed, the first random access procedure is initiated.

In one embodiment, as a response to a beam failure with respect to the second RS resource group being detected, when an evaluation of candidate beams for the second RS resource group has been successfully completed, if the first BFR is in a pending state and the second random access procedure is not being performed, initiating the first random access procedure.

In one embodiment, as a response to a beam failure with respect to the first RS resource group being detected and an evaluation of candidate beams for the first RS resource group having been successfully completed, and, as a response to a beam failure with respect to the second RS resource group being detected and an evaluation of candidate beams for the second RS resource group having been successfully completed, and the second random access procedure is not being performed, initiating the first random access procedure.

### Embodiment 13

Embodiment 13 illustrates a structure block diagram of a processing device used in a first node according to one embodiment of the present application, as shown in FIG. 13. In FIG. 13, a processing device 1300 in a first node is comprised of a first receiver 1301 and a first transceiver 1302.

The first receiver 1301 receives a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource; and increments a first counter by 1 whenever a radio link quality evaluated according to the first RS resource group is worse than a first threshold; and increments a second counter by 1 whenever a radio link quality evaluated according to the second RS resource group is worse than a second threshold;

the first transmitter 1302 triggers a first BFR as a response to at least the first counter reaching a first value; any condition in a first candidate condition set being satisfied being used to determine cancelling the first BFR.

In Embodiment 13, a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, as a response to the first counter reaching the first value, the first random access procedure not being performed is used to determine triggering of the first BFR.

In one embodiment, the first transceiver 1302 initiates the first random access procedure as a response to at least the first counter reaching the first value and the second counter reaching the second value; the first condition being satisfied as a response to the first random access procedure being initiated; and cancels the first BFR as a response to the first condition being satisfied.

In one embodiment, the first transceiver 1302 triggers a first SR as a response to the action of triggering a first BFR; and, if the first SR is in a pending state, cancels the first SR as a response to the first condition being satisfied.

In one embodiment, the first transceiver 1302 triggers a first SR as a response to the action of triggering a first BFR; and initiates a second random access procedure as a response to the action of triggering a first SR; and suspends the second random access procedure as a response to the first condition being satisfied if the second random access procedure is being performed.

In one embodiment, the first transceiver 1302 determines whether to initiate the first random access procedure according to whether a second random access procedure is being performed, as a response to at least the first counter reaching the first value and the second counter reaching the second value; and does not initiate the first random access procedure if the second random access procedure is being performed; herein, the second random access procedure is triggered by a first SR, the first SR being triggered by the first BFR.

In one embodiment, the first receiver 1301 determines that the first random access procedure is completed; the first condition being satisfied as a response to the action of determining that the first random access procedure is completed; and cancels the first BFR as a response to the first condition being satisfied.

In one embodiment, the failure information for the first BFR is indicated in the first random access procedure.

In one embodiment, the first transceiver 1302 transmits a first BFR MAC CE on a second uplink grant; and determines whether the first condition is satisfied according to whether the second uplink grant is associated with the first random access procedure, as a response to the first BFR MAC CE being transmitted on the second uplink grant; the first condition being satisfied if the second uplink grant is associated with the first random access procedure; and cancels the first BFR as a response to the first condition being satisfied.

In one embodiment, the first transceiver 1302 transmits a second BFR MAC CE as a response to the action of triggering a first BFR; the first receiver 1301 determines whether to monitor a first PDCCH according to whether a first random access procedure is being performed as a response to the action of transmitting a second BFR MAC CE; and does not monitor the first PDCCH if the first random access procedure is being performed.

In one embodiment, the first transceiver 1302 transmits a second BFR MAC CE as a response to the action of triggering a first BFR; the first receiver 1301 receives the first PDCCH transmission; the second condition being satisfied as a response to the first PDCCH transmission being received; and cancels the first BFR as a response to the second condition being satisfied; herein, the second BFR MAC CE is used to trigger the first PDCCH transmission.

In one embodiment, the first transceiver 1302 suspends the first random access procedure as a response to the second condition being satisfied.

In one embodiment, the first transceiver 1302 transmits a third BFR MAC CE on the first uplink grant as a response to the second condition being satisfied.

In one embodiment, the first receiver 1301 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises the antenna 452, the receiver 454, the multi-antenna receiving processor 458 and the receiving processor 456 in FIG. 4 of the present application.

In one embodiment, the first receiver 1301 comprises the antenna 452, the receiver 454 and the receiving processor 456 in FIG. 4 of the present application.

In one embodiment, the first transceiver 1302 comprises the antenna 452, the transmitter 454, the multi-antenna transmitting processor 457, the transmitting processor 468, the receiver 454, the multi-antenna receiving processor 458, the receiving processor 456, the controller/processor 459, the memory 460 and the data source 467 in FIG. 4 of the present application.

In one embodiment, the first transceiver 1302 comprises the antenna 452, the transmitter 454, the multi-antenna transmitting processor 457, the transmitting processor 468, the receiver 454, the multi-antenna receiving processor 458 and the receiving processor 456 in FIG. 4 of the present application.

In one embodiment, the first transceiver 1302 comprises the antenna 452, the transmitter 454, the transmitting processor 468, the receiver 454 and the receiving processor 456 in FIG. 4 of the present application.

### Embodiment 14

Embodiment 14 illustrates a structure block diagram of a processing device used in a second node according to one embodiment of the present application, as shown in FIG. 14. In FIG. 14, a processing device 1400 in a second node is comprised of a second transmitter 1401 and a second receiver 1402.

The second transmitter 1401 transmits a first signaling, the first signaling indicating a first RS resource set, the first RS resource set comprising at least a first RS resource group and a second RS resource group, the first RS resource group comprising at least one RS resource, and the second RS resource group comprising at least one RS resource, the first RS resource group and the second RS resource group comprising at least one different RS resource.

In Embodiment 14, a first counter is incremented by 1 whenever a radio link quality evaluated according to the first RS resource group is worse than a first threshold; and a second counter is incremented by 1 whenever a radio link quality evaluated according to the second RS resource group is worse than a second threshold; and a first BFR is triggered as a response to at least the first counter reaching a first value; any condition in a first candidate condition set being satisfied is used to determine cancelling of the first BFR; a first condition is a candidate condition in the first candidate condition set, the first condition being related to a first random access procedure; whether the first random access procedure is initiated by a receiver of the first signaling is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the receiver of the first signaling, and the first PDCCH transmission indicating a first uplink grant, the first uplink grant being used for new data transmission; the first threshold and the second threshold are configurable; the first value and the second value are configurable, and the first value and the second value are each a positive integer.

In one embodiment, as a response to the first counter reaching the first value, the first random access procedure not being performed is used to determine triggering of the first BFR.

In one embodiment, the first random access procedure is initiated as a response to at least the first counter reaching the first value and the second counter reaching the second value; the first condition being satisfied as a response to the first random access procedure being initiated; and the first BFR is canceled as a response to the first condition being satisfied.

In one embodiment, as a response to the first BFR being triggered, a first SR is triggered; as a response to the first condition being satisfied, if the first SR is in pending state, the first SR is canceled.

In one embodiment, as a response to the first BFR being triggered, a first SR is triggered; as a response to the first SR being triggered, a second random access procedure is initiated by a receiver of the first signaling; as a response to the first condition being satisfied, the second random access procedure is suspended by the receiver of the first signaling if the second random access procedure is being performed.

In one embodiment, as a response to at least the first counter reaching the first value and the second counter reaching the second value, whether a second random access procedure is being performed is used to determine whether the first random access procedure is initiated by a receiver of the first signaling; if the second random access procedure is being performed, the first random access procedure is not initiated by the receiver of the first signaling; herein, the second random access procedure is triggered by a first SR, the first SR being triggered by the first BFR.

In one embodiment, the first random access procedure is determined by a receiver of the first signaling to have been completed; as a response to the first random access procedure being determined by the receiver of the first signaling to have been completed, the first condition is satisfied; as a response to the first condition being satisfied, the first BFR is canceled by the receiver of the first signaling.

In one embodiment, the failure information for the first BFR is indicated in the first random access procedure.

In one embodiment, the second receiver 1402 receives a first BFR MAC CE on a second uplink grant; herein, as a response to the first BFR MAC CE being transmitted by a receiver of the first signaling on the second uplink grant, whether the second uplink grant is associated with the first random access procedure is used to determine whether the first condition is satisfied; if the second uplink grant is associated with the first random access procedure, the first condition is satisfied; as a response to the first condition being satisfied, the first BFR is canceled by a receiver of the first signaling.

In one embodiment, the second receiver 1402 receives a second BFR MAC CE; the second transmitter 1401 transmits a first PDCCH transmission as a response to the action of receiving a second BFR MAC CE; herein, the first PDCCH is not monitored by a receiver of the first signaling if the first random access procedure is being performed.

In one embodiment, the second receiver 1402 receives a second BFR MAC CE; the second transmitter 1401 transmits the first PDCCH transmission as a response to the second BFR MAC CE being received; herein, as a response to the first PDCCH transmission being received by a receiver of the first signaling, the second condition is satisfied; and as a response to the second condition being satisfied, the first BFR is canceled by the receiver of the first signaling.

In one embodiment, as a response to the second condition being satisfied, the first random access procedure is suspended by a receiver of the first signaling.

In one embodiment, the second receiver 1402 receives a second BFR MAC CE; the second receiver 1402 receives a third BFR MAC CE on the first uplink grant as a response to the action of receiving a second BFR MAC CE; herein, the second condition being satisfied is used to trigger the third BFR MAC CE.

In one embodiment, the second transmitter 1401 determines whether to transmit a first PDCCH transmission according to whether the first random access procedure is being performed; and does not transmit the first PDCCH transmission if the first random access procedure is being performed.

In one embodiment, the second transmitter 1401 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises the antenna 420, the transmitter 418, the multi-antenna transmitting processor 471 and the transmitting processor 416 in FIG. 4 of the present application.

In one embodiment, the second transmitter 1401 comprises the antenna 420, the transmitter 418 and the transmitting processor 416 in FIG. 4 of the present application.

In one embodiment, the second receiver 1402 comprises the antenna 420, the receiver 418, the multi-antenna receiving processor 472, the receiving processor 470, the controller/processor 475 and the memory 476 in FIG. 4 of the present application.

In one embodiment, the second receiver 1402 comprises the antenna 420, the receiver 418, the multi-antenna receiving processor 472 and the receiving processor 470 in FIG. 4 of the present application.

In one embodiment, the second receiver 1402 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling indicating a first RS resource set, the first RS resource set comprising at least a first RS resource group and a second RS resource group, the first RS resource group and the second RS resource group being associated with a first cell, the first RS resource group comprising at least one RS resource, and the second RS resource group comprising at least one RS resource, the first RS resource group and the second RS resource group comprising at least one different RS resource; and incrementing a first counter by 1 whenever a radio link quality evaluated according to the first RS resource group is worse than a first threshold; and incrementing a second counter by 1 whenever a radio link quality evaluated according to the second RS resource group is worse than a second threshold; and
a first transceiver, triggering a first BFR as a response to at least the first counter reaching a first value; any condition in a first candidate condition set being satisfied being used to determine cancelling the first BFR;
wherein a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.

2. The first node according to claim 1, characterized in that as a response to the first counter reaching the first value, the first random access procedure not being performed is used to determine triggering of the first BFR.

3. The first node according to claim 1, characterized in comprising:
the first transceiver, determining whether to initiate the first random access procedure according to whether a second random access procedure is being performed, as a response to at least the first counter reaching the first value and the second counter reaching the second value; and not initiating the first random access procedure if the second random access procedure is being performed;
wherein the second random access procedure is triggered by a first SR, the first SR being triggered by the first BFR.

4. The first node according to claim 1, characterized in comprising:
the first receiver, determining that the first random access procedure is completed; and the first condition being satisfied as a response to the action of determining that the first random access procedure is completed; and cancelling the first BFR as a response to the first condition being satisfied.

5. The first node according to claim 4, characterized in that having received a PDCCH is used to determine completion of the first random access procedure; the PDCCH is associated with the first identifier of the first node, the first PDCCH transmission indicating a UL grant used for new data transmission.

6. The first node according to claim 4, characterized in that the first condition is satisfied as a response to the action of determining that the first random access procedure is completed; wherein failure information for the first BFR is indicated in the first random access procedure.

7. The first node according to claim 4, characterized in comprising:
the first transceiver, if the failure information for the first BFR is indicated in the first random access procedure, cancelling the first BFR as a response to the action of determining that the first random access procedure is completed.

8. The first node according to claim 1, characterized in comprising:
the first transceiver, transmitting a first BFR MAC CE on a second uplink grant; and determining whether the first condition is satisfied according to whether the second uplink grant is associated with the first random access procedure, as a response to the first BFR MAC CE being transmitted on the second uplink grant; the first condition being satisfied if the second uplink grant is associated with the first random access procedure; and cancelling the first BFR as a response to the first condition being satisfied.

9. The first node according to claim 1, characterized in comprising:
the first transceiver, transmitting a second BFR MAC CE as a response to the action of triggering a first BFR; and
the first receiver, receiving the first PDCCH transmission; the second condition being satisfied as a response to the first PDCCH transmission being received; and cancelling the first BFR as a response to the second condition being satisfied;
wherein the second BFR MAC CE is used to trigger the first PDCCH transmission.

10. The first node according to claim 1, characterized in that the phrase the first condition being related to a first random access procedure comprises that: the first condition is related to the first random access procedure being completed,
or,
the phrase the first condition being related to a first random access procedure comprises that: the first condition is related to whether failure information for the first BFR is transmitted in the first random access procedure,
or,
the phrase the first condition being related to a first random access procedure comprises that: the first condition is related to whether a random access preamble for the first random access procedure is associated with the first RS resource group.

11. The first node according to claim 1, characterized in that the first identifier of the first node includes a C-RNTI of the first node; the first cell is a SpCell of the first node.

12. The first node according to claim 1, characterized in that the first RS resource group and the second RS resource group both belong to the first cell.

13. The first node according to claim 1, characterized in that the first RS resource group belongs to the first cell, while the second RS resource group belongs to a second cell; a PCI of the first cell is different from a PCI of the second cell.

14. The first node according to claim 1, characterized in that the first signaling indicates an index of each RS resource in the first RS resource set.

15. The first node according to claim 1, characterized in that the first signaling is generated in MAC; the phrase a radio link quality evaluated according to the first RS resource group comprises: a radio link quality obtained by performing a measurement with respect to each RS resource in the first RS resource group; the phrase a radio link quality evaluated according to the second RS resource group comprises: a radio link quality obtained by performing a measurement with respect to each RS resource in the second RS resource group.

16. The first node according to claim 1, characterized in that the first signaling is generated in RRC; the phrase a radio link quality evaluated according to the first RS resource group comprises: a radio link quality obtained by performing a measurement with respect to each RS resource in one subset of the first RS resource group; the phrase a radio link quality evaluated according to the second RS resource group comprises: a radio link quality obtained by performing a measurement with respect to each RS resource in one subset of the second RS resource group.

17. The first node according to claim 1, characterized in that any RS resource in the first RS resource group is periodic; an RS resource in the first RS resource group is a CSI-RS resource identified by csi-RS-Index or an SSB resource identified by ssb-Index; any RS resource in the second RS resource group is periodic; an RS resource in the second RS resource group is a CSI-RS resource identified by csi-RS-Index or an SSB resource identified by ssb-Index.

18. The first node according to claim 1, characterized in that the action of cancelling the first BFR comprises: cancelling all BFRs triggered for the first RS resource group.

19. A second node for wireless communications, comprising:
a second transmitter, transmitting a first signaling, the first signaling indicating a first RS resource set, the first RS resource set comprising at least a first RS resource group and a second RS resource group, the first RS resource group and the second RS resource group being associated with a first cell, the first RS resource group comprising at least one RS resource, and the second RS resource group comprising at least one RS resource, the first RS resource group and the second RS resource group comprising at least one different RS resource;
wherein a first counter is incremented by 1 whenever a radio link quality evaluated according to the first RS resource group is worse than a first threshold; and a second counter is incremented by 1 whenever a radio link quality evaluated according to the second RS resource group is worse than a second threshold; and a first BFR is triggered as a response to at least the first counter reaching a first value; any condition in a first candidate condition set being satisfied is used to determine cancelling the first BFR;
a first condition is a candidate condition in the first candidate condition set, the first condition being related to a first random access procedure; whether the first random access procedure is initiated by a receiver of the first signaling is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the receiver of the first signaling, and the first PDCCH transmission indicating a first uplink grant, the first uplink grant being used for new data transmission; the first threshold and the second threshold are configurable; the first value and the second value are configurable, and the first value and the second value are each a positive integer.

20. A method in a first node for wireless communications, comprising:
receiving a first signaling, the first signaling indicating a first RS resource set, the first RS resource set comprising at least a first RS resource group and a second RS resource group, the first RS resource group and the second RS resource group being associated with a first cell, the first RS resource group comprising at least one RS resource, and the second RS resource group comprising at least one RS resource, the first RS resource group and the second RS resource group comprising at least one different RS resource; and incrementing a first counter by 1 whenever a radio link quality evaluated according to the first RS resource group is worse than a first threshold; and incrementing a second counter by 1 whenever a radio link quality evaluated according to the second RS resource group is worse than a second threshold; and
triggering a first BFR as a response to at least the first counter reaching a first value; any condition in a first candidate condition set being satisfied being used to determine cancelling the first BFR;
wherein a first condition is a candidate condition in the first candidate condition set, the first condition being related to a first random access procedure; whether to initiate the first random access procedure is related to at least whether the first counter reaches the first value and whether the second counter reaches a second value; a second condition is a candidate condition in the first candidate condition set, the second condition comprising that a first PDCCH transmission is received, the first PDCCH transmission being associated with a first identifier of the first node, and the first PDCCH transmission indicating a first uplink grant, the first uplink grant being used for new data transmission; the first threshold and the second threshold are configurable; the first value and the second value are configurable, and the first value and the second value are each a positive integer.
